(19) United States
(12) Patent Application Publication
(10) Pub. No.: US 2025/0046858 A1
(43) Pub. Date: Feb. 6, 2025

(54) TEMPLATE FOR ACHIEVING ANODE-FREE AND ANODELESS BATTERIES

(71) Applicant: BOARD OF REGENTS, THE UNIVERSITY OF TEXAS SYSTEM, Austin, TX (US)

(72) Inventors: David MITLIN, Hannawa Falls, NY (US); Hui DONG, Pearland, TX (US); Yixian WANG, Austin, TX (US)

(21) Appl. No.: 18/717,052

(22) PCT Filed: Dec. 7, 2022
(86) PCT No.: PCT/US2022/052138

§ 371 Date: Jun. 6, 2024

Related U.S. Application Data
(60) Provisional application No. 63/287,386, filed on Dec. 8, 2021.
(60) Provisional application No. 63/328,816, filed on Apr. 8, 2022.

(51) Int. Cl. H01M 10/054; H01M 4/02; H01M 4/04; H01M 4/1395; H01M 4/38; H01M 10/0525; H01M 10/0562

(52) U.S. Cl. CPC H01M 10/054; H01M 4/0404; H01M 4/1395; H01M 4/381; H01M 10/0562; H01M 2004/027; H01M 2004/028; H01M 10/0525

(57) ABSTRACT

Disclosed is an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and wherein the ionophilic template is a support material for a metal anode. Also disclosed are electrochemical cells comprising such templates and methods of making and using the same.

### CROSS-REFERENCE TO RELATED APPLICATIONS

This application claims the benefit of U.S. Provisional Application No. 63/328,816, filed Apr. 8, 2022, and U.S. Provisional Application No. 63/287,386, filed Dec. 8, 2021, the contents of which are incorporated herein by reference in their entirety.

### STATEMENT ACKNOWLEDGING GOVERNMENT SUPPORT

This invention was made with government support under Grant Nos. DE-AC52-06NA25396 awarded by the Department of Energy and DMR1938833 awarded by the National Science Foundation. The government has certain rights in the invention.

### TECHNICAL FIELD

This application relates generally to electrochemical cells having ionophilic templates comprising a microscopic array and wherein the ionophilic templates represent a support material for a metal anode.

### BACKGROUND

Sodium metal holds considerable promise as an anode material for Na-based batteries, considering its high capacity of 1166 mAh g⁻¹ and low redox potential of −2.71 V versus standard hydrogen electrode (SHE). Dendrite growth is ubiquitous when electroplating a wide range of metals in a similarly wide range of electrolytes. Dendrite growth is well recognized as the major impediment to the implementation of metal anodes for both Na and Li batteries. Sodium-metal anodes are hampered by somewhat analogous issues as Li anodes but to a worse extent: repeated electrodeposition/electrostripping of Na is accompanied by concurrent dendrite growth and unstable solid electrolyte interphase (SEI). This, in turn, leads to a series of key issues, including a marked rise in cell impedance, low Coulombic efficiency (CE), electrolyte exhaustion, and premature cell failure that may be catastrophic. For example, SEI-induced electrolyte depletion and dendrite growth through the battery separator are well-documented. Significant gains have been achieved in promoting stable dendrite-free cycling of Li metal anodes. In contrast, cycling stability with Na-metal anodes remains more limited due to its greater reactivity in battery electrolytes.

Both Li and Na metals occupy a higher energy level compared with the lowest unoccupied molecular orbital (LIMOs) of organic electrolytes. Since the number of electron shells in Na is larger than in Li, there is a lower constraining force on the outermost electrons. This causes Na to be a more reactive agent than Li in comparable electrolytes. Sodium also possesses a 55% larger ionic radius than Li and has a notably weaker bonding with solid carbon resulting in less exothermic adsorption/intercalation. In carbonate- or ether-based solvents, Na metal is more reactive than Li metal when evaluated under identical conditions. These include various combinations of carbonates such as ethylene carbonate (EC), propylene carbonate (PC), diethyl carbonate (DEC), dimethyl carbonate (DMC), dimethoxyethane (DME), diglyme (G2), and tetraglyme (G4).

Compared to Li metal, Na-metal anodes in ether and ester solvents possess accelerated SEI growth, worse CE, larger overpotentials for plating and stripping, and more severe growth of dendrites. The morphology of Na dendritesis varied but is often described as “needle-like,” “filament-like,” or “mossy.” In the case of Li, these shapes are associated with defect-catalyzed base growth conditions at currents low enough where ion-diffusional limitations do not yet dominate. Likely, this is also the case for Na dendrites, although the role of SEI in the growth morphology requires further analysis.

To address the above challenges, numerous strategies have been proposed, such as the formation of SEI film in situ by adding electrolyte additives, the fabrication of an artificial protection layer on the Na-metal surface, construction of 3D hosts for Na metal, and regulation of Na deposition by controlling the nucleation sites. Creating sodiophilic surfaces to promote metal wetting during deposition and, in parallel, reduce the nucleation/growth overpotentials has been shown to be highly effective.

In most studies, improved Na plating/stripping performance is demonstrated using unrealistically thick anodes, for example, 300 mm to 1 mm foils. Such thick anode foils contribute inactive metal to the weight and the volume of the battery. Thick metal anodes also pose an increased safety risk due to the overall larger amount of reactive metal. For research applications, however, a relatively low depth-of-discharge (DOD) of several percent will give a more favorable assessment of cell cycling performance. The plating-stripping volume changes (relative to the total anode thickness) is less, and there is always fresh metal to compensate for ongoing SEI formation and other sources of CE loss. A survey of state-of-the-art Na-metal anode literature showed that a typical DOD was less than 5% of the overall metal-foil capacity. A volume change of 5% is less disruptive to the anode and to the SEI than the oft-quoted infinite volume change corresponding to 100% DOD.

More challenging configuration-based deep cycling conditions and, respectively, greater DOD have been proposed as the research path forward. One method to study deep discharge/charge (stripping/plating) is to employ “anodeless”/“anode-free” configurations where the active ions are stored entirely in the cathode while the anode is effectively a blank current collector. This, of course, results in 100% DOD per cycle and represents the most challenging configuration. Another method to achieve a large DOD is to employ thin foils, e.g., 50 μm, with aggressive cycling in terms of plated/stripped capacities. It should also be pointed out that thin (5-50 μm range) Na-metal anodes are needed for commercially viable NMBs. While such Na foils are currently not available, this serves as the appropriate target for future development efforts.

Thus, innovative approaches to providing stable and efficient anodeless batteries are needed. These needs and other needs are at least partially satisfied by the present disclosure.

### SUMMARY

The present disclosure is directed to an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1; wherein the microscopic array is dispersed within a metal comprising the M, and wherein the ionophilic template is a support material for a metal anode.

In further aspects, a ratio of Sb to the M is from greater than 0 to 100 wt % and wherein a ratio of Te to the M is from greater than 0 to 100 wt %.

While in still further aspects, the ionophilic template is configured to provide a coulombic efficiency of the metal anode greater than 50% at a current density from about 0.1 mA cm⁻² to about 10 mA cm⁻².

In yet still, further aspects, disclosed herein is an electrochemical cell comprising a) a support material for a metal anode comprising an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and b) an electrolyte.

In yet still, further aspects, disclosed herein is an electrochemical cell comprising a) a support material for a metal anode comprising an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and b) a solid electrolyte comprising sulfide compounds, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Further disclosed herein are aspects where the electrochemical cell is a battery.

Still further disclosed is the electrochemical cell, where the at least one electrode is an anode and/or cathode. In such exemplary aspects, the anode can comprise ions and/or metals of potassium, sodium, lithium, or a combination thereof. While in other aspects, the cathode can comprise a metal cathode or a composite cathode.

In yet further aspects, the electrolyte can comprise a salt and a non-aqueous solvent.

Also disclosed herein is a method of making an ionophilic template: disposing an amount of Sb₂Te₃ within a metal M to form a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 depicts the fabrication process of sodium-antimony-telluride-Na metallurgical composite, termed NST-Na (left). The structure was obtained by repeated rolling and folding of Sb₂Te₃ powder and a Na-metal foil. An in-situ-formed electrochemically stable intermetallic NST skeleton supports an electrochemically active Na-metal matrix. On the right are shown photographs, taken inside the glove box, of the 150 μm thick self-standing NST-Na foil.

FIG. 2 depicts two configurations employed for battery assembly and testing. Configuration 1 is NST-Na or NST (Na metal stripped) electrodes being supported by standard stainless steel (SS) coin cell spacer. This architecture was employed for extensive electrochemical testing, e.g., cycling and rate performance. Configuration 2 has NST-Na or NST being supported by a standard Cu current collector, which is, in turn, placed on the SS spacer. This configuration was employed for the targeted tests where the specimens that would then undergo post-mortem analytical characterization are better suited to removing the NST-Na or NST electrodes from the coin cell and separating them from the collector.

FIGS. 3A-3C show SEM images and associated particle size distribution of as-received Sb₂Te₃ powder used as the precursor for NST-Na electrodes.

FIGS. 4A-4C show SEM images and EDX maps of the as-synthesized NST-Na anode. FIG. 4A shows a cross-sectional view. FIGS. 4B-4C shows a top-down view.

FIGS. 5A-5P show an XRD analysis of as-synthesized NST-Na along with the DFT simulation of Na₂(Sb_{2/6}Te_{3/6}Vac_{1/6}) structure based on archetype fcc Na₂Te (FIG. 5A). Inset is the representative crystal structure of NST from cluster enumeration, and the unit cell is indicated by the red dotted box. Color scheme: Na (yellow), Sb (brown), and Te (green). FIGS. 5B-5C show high-resolution XPS spectra of NST showing the fitted Sb 3d and Te 3d peaks. FIG. 5D shows a photograph of an as-fabricated NST-Na anode. FIG. 5E shows a photograph of NST after Na was fully stripped from the electrode. FIG. 5F shows a photograph of fully-stripped NST followed by plating of 2 mAh cm⁻² capacity. FIG. 5G shows a photograph of the baseline Cu current collector with a plated capacity of 2 mAh cm⁻². FIG. 5H shows a photograph of the baseline Cu current collector, with Na fully stripped. FIGS. 5I-5J show FIB cross-sectional SEM images and FIGS. 5K-5L show FIB-SEM tomography of NST, highlighting its interconnected 3D structure, showing the front views and the back views, respectively. FIGS. 5M-5N show SEM images of the baseline Cu current collector with a plated capacity of 0.5 mAh cm⁻² at cycle 1.

FIGS. 50-5P show the same analysis for NST. Testing for FIGS. 5M-5P was performed in 1 M NaPF₆ in the G2 electrolyte.

FIGS. 6A-6C depict the primitive structure of Na2Te used for cluster enumeration (FIG. 6A). The transformation matrix applied to lattice parameters and atomic positions of structure on the left to obtain the enumerated structure is shown in FIG. 6B. FIG. 6C shows the DFT optimized geometry with antimony substituted Te and vacancy in a red dotted circle. Color scheme: Na (yellow), Te (green), Sb (brown). Structure plotted using VESTA.

FIGS. 7A-7D depict a schematic illustration of Na₂Te (FIGS. 7A-7B) and NST crystal structure (FIGS. 7C-7D).

FIGS. 8A-8B depict XRD patterns of Na3Sb, Na2Te, and Na metal mixed with Sb2Te3 (NST-Na), Sb (NSNa), and Te (NT-Na) powder (FIG. 8A), and XRD patterns of NST-Na and Sb2Te3 powder (FIG. 8B)

FIG. 9 shows XRD profiles of NST-Na after various rolling and folding iterations (2-20).

FIGS. 10A-10B show XRD profiles of NST-Na with a different initial weight loading of Sb₂Te₃ taken before Na metal was electrochemically stripped from the anode (FIG. 10A), and XRD profiles of NST (Na metal fully-stripped) with a different initial weight loading of Sb₂Te₃ taken after Na metal was electrochemically stripped from the anode (FIG. 10B).

FIG. 11 shows XRD patterns directly comparing NST and NST-Na electrodes.

FIGS. 12A-12B show a top view SEM image and EDX map of the post-stripped NST supported on Cu substrate (FIG. 12A) and analogous cross-section view analysis (FIG. 12B).

FIGS. 13A-13C show a FIB cross-sectional SEM image with EDXS mapping of NST (FIG. 13A), associated EDX spectrum (FIG. 13B) and obtained quantitative elemental results (FIG. 13C).

FIGS. 14A-14C show TEM images of the associated indexed SAED ring pattern of NST.

FIGS. 15A-15D depict FIB cross-sectional Sem images of NSTs corresponding to different initial weight loadings of Sb₂Te₃.

FIGS. 16A-16B show XRD profiles on NST on different substrates (FIG. 16A) and FIB cross-sectional SEM of NST of the SS spacer (FIG. 16B).

FIGS. 17A-17D show SEM images of NST on a Cu current collector with a plated capacity of 0.5 mAh cm⁻², tested at 1 mA cm⁻² in 1 M NaFSI in EC/DEC (FIGS. 17A-17B), and the same analysis but for the bare Cu foil (FIGS. 17C-17D).

FIGS. 18A-18I show an electrochemical performance of symmetric cells based on NST-Na and baseline Na. FIG. 18A shows voltage profiles at 0.5 mA cm⁻² to a capacity of 0.25 mAh cm⁻² per cycle in 1 M NaFSI in EC/DEC. FIG. 18B shows voltage profiles at 1 mA cm⁻² to a capacity of 1 mAh cm⁻² per cycle in 1 M NaFSI in EC/DEC. FIG. 18C shows voltage profiles at 2 mA cm⁻² to a capacity of 10 mAh cm⁻² per cycle in 1 M NaPF₆/G2. FIG. 18D shows rate performance at 0.5, 1, 2, and 5 mA cm⁻² to 1 mAh cm⁻² per cycle in 1 M NaFSI in EC/DEC. FIGS. 18E-18F show galvanostatic profiles at 0.5 mA cm⁻² at cycle 5 and associated magnified view in 1 M NaFSI in EC/DEC. FIG. 18G shows average overpotentials at 0.5 and 1 mA cm⁻² in 1 M NaFSI in EC/DEC. FIG. 18H shows EIS Nyquist plots after 5 cycles at 0.5 mA cm⁻² to 1 mAh cm⁻² per cycle in 1 M NaFSI in EC/DEC. FIG. 18I shows a voltage profile at cycle 5 of asymmetric NST-Na∥Na cells, at 0.5 mA cm⁻², in 1 M NaFSI in EC/DEC.

FIGS. 19A-19C show the electrochemical performance of NST-Na∥NST-Na symmetrical cells tested at different current densities and plating capacities in 1 M NaFSI in EC/DEC.

FIG. 20 shows an electrochemical performance of NT-Na∥NT-Na and NS-Na∥NS-Na symmetrical cells tested at 0.5 mA cm⁻² to 0.25 mAh cm⁻² capacity per cycle in 1 M NaFSI in EC/DEC.

FIG. 21 shows voltage profiles of NST-Na∥NST-Na symmetrical cells with different starting weight loadings of Sb₂Te₃. Cells tested at 0.5 mA cm⁻² to 0.25 mAh cm⁻² capacity per cycle in 1 M NaFSI in EC/DEC.

FIG. 22 shows cycle 5 galvanostatic voltage profile for a Na∥Cu cell (half-cell) in 1 M NaFSI in EC/DEC.

FIGS. 23A-23B show cycle 5 galvanostatic profiles of NST-Na∥NST-Na and baseline Na∥Na cells tested at 0.5 mA cm⁻². FIG. 23A is tested in 1 M NaClO₄ in EC/DEC and FIG. 23B is tested in 1 M NaClO₄ in EC/PC/FEC.

FIGS. 24A-24E show the electrochemical performance of NST-Na cells under deep-cycling conditions in 1 M NaPF₆ in G2 electrolyte. FIG. 24A shows NST-Na cells cycled under different DOD at 1 mA cm⁻². FIG. 24B-24E show voltage profiles, Coulombic efficiencies (CEs), and average plating overpotentials for NST-Na electrode cycled under 100% DOD at 1 mA cm⁻². Active Na was first stripped from the NST-Na electrode (the last step shown in (FIG. 24A)), and then Na was repeatedly plated/stripped.

FIG. 25 shows XRD patterns for NST-Na before and after 5 cycles of Na plating/stripping at 0.5 mA cm⁻² with a plating/stripping capacity of 1 mAh cm⁻² per cycle in 1 M NaFSI in EC/DEC.

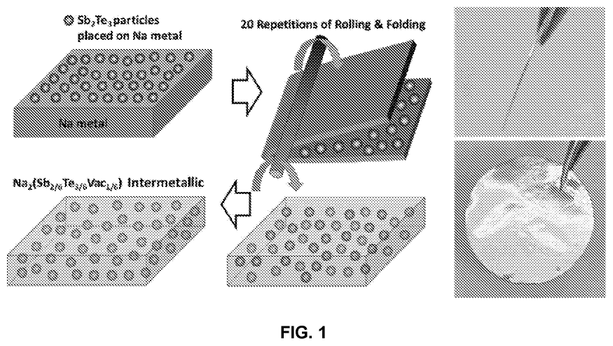

FIGS. 26A-26B show NST-Na cells cycled under different DOD at 1 mA cm⁻² in 1 M NaFSI in EC/DEC (FIG. 26A) and 1 M NaClO₄ in EC/PC/FEC (FIG. 26B).

FIGS. 27A-27C show baseline Na cells cycled under different DOD at 1 mA cm⁻² in 1 M NaFSI in EC/DEC (FIG. 27A), 1 M NaClO₄ in EC/PC/FEC (FIG. 27B), and 1 M NaPF₆ in G2 (FIG. 27C).

FIGS. 28A-28B show voltage profiles and coulombic efficiencies of NST-Na electrode cycled under 100% DOD at 3 mA cm⁻² (FIG. 28A) and at 5 mA cm⁻² in 1 M NaPF₆ in G2 (FIG. 28B).

FIGS. 29A-29H show XPS spectra comparing the SEI for fifth cycle plated surfaces of NST-Na versus baseline Na in 1 M NaFSI in EC/DEC. FIGS. 29A-29D show NST-Na, fitted C 1s, O 1s, and F 1≤spectra and bar charts showing the relative percentage of different species in the SEI. FIGS. 29E-29H show the same analysis but for baseline Na.

FIGS. 30A-30L show microscopic analysis comparing NST-Na versus Na in the plated condition (1 M NaFSI in EC/DEC, 5 cycles at 0.5 mA cm⁻² with a plated capacity of 1 mAh cm⁻² per cycle). FIG. 30A shows a top-view SEM image of the post-cycled NST-Na. FIG. 30B shows Cryo-FIB lift-out specimen. FIGS. 30C-30D show a Cryo-FIB cross-sectional SEM image and EDXS map of the post-cycled NST-Na. FIGS. 30E-30H show the same analysis but for baseline Na. FIGS. 301-30J show Cryo-TEM images of the post-cycled NST-Na and FIGS. 30K-30L show the same analysis but for Na, with arrows highlighting the porosity in the metal.

FIGS. 31A-31D show SEM images comparing the top view and cross-sectional views of NST-Na and baseline N at identically plated conditions. Analyzed after 1 cycle at 1 mA cm⁻² to a plating capacity of 5 mAh cm⁻² in 1 M NaFSI in EX/DEC. FIGS. 31A-31B show NST results and FIGS. 31C-31D show baseline Na.

FIGS. 32A-32D show SEM images comparing the top view and cross-sectional views of NST-Na and baseline N at identically plated conditions. Analyzed after 1 cycle at 1 mA cm⁻² to a plating capacity of 10 mAh cm⁻² in 1 M NaFSI in EX/DEC. FIGS. 32A-32B show NST results and FIGS. 32C-32D show baseline Na.

FIGS. 33A-33E show SEM images comparing the top view and cross-sectional views of NST-Na and baseline N at identically plated conditions. Analyzed after 1 cycle at 1 mA cm⁻² to a plating capacity of 26 mAh cm⁻² in 1 M NaFSI in EX/DEC. FIGS. 33A-33B show NST results and FIGS. 33C-33E show baseline Na.

FIGS. 34A-34I show voltage profiles of NST-Na∥NVP and Na∥NVP cells in 1 M NaFSI in EC/DEC electrolyte at 1 C (FIG. 34A). Three-electrode analysis showing a voltage of NVP cathode and Na anode (FIG. 34B). Cycling stability of NST-Na∥NVP and Na∥NVP cells at 1 C (FIG. 34C). Selected voltage profiles of NST-Na∥S and Na∥S cells at 0.5 C in 1 M NaFSI in EC/DEC (FIG. 34D). Cycling stability and CE of NST-Na∥S and Na∥S at 0.5 C in 1 M NaFSI in EC/DEC (FIG. 34E). Cycling stability and CE of NST-Na∥S and Na∥S cells at 0.5 C in 1 M NaClO₄ in EC/PC/FEC (FIG. 34F). Voltage profiles of Na∥NVP and Cu∥NVP at 1 C in 1 M NaPF₆ in G2 (FIG. 34G). Voltage profiles and cycling performance of an anode-free cell with an NVP cathode (source of Na) and NST versus baseline Cu collector at 1 C in 1 M NaPF₆ in G2 (FIGS. 34H-34I).

FIGS. 35A-35B show a rate comparison of full cells based on NST-Na∥NVP and Na∥NVP cells, tested in 1 M NaFSI in EC/DEC (FIG. 35A). Same analysis for NST-Na∥S and Na∥S cells, tested in 1 M NaClO₄ in EC/PC/FEC (FIG. 35B).

FIGS. 36A-36C show specific energy (FIG. 36A) and Coulombic Energy (FIG. 36B) of NST-Na∥NVP and Na∥NVP cells, tested at 1 C in 1 M NaFSI in EC/DEC Cycling performance of an NST-Na∥NVP cell at 10 C (FIG. 36C).

FIGS. 37A-37B show the first cycle (FIG. 37A) and third cycle (FIG. 37B) voltage profiles of NST-Na∥S and baseline Na∥S cells, tested in 1 M NaClO₄ in EC/PC/FEC.

FIGS. 38A-38D show SEM images of the anode current collector surface for an anode-free NST∥NVP cell, analyzed after a single plating-stripping cycle at 1 C in 1 M NaPF₆ in G2 (FIGS. 38A-38B). FIGS. 38C-38D show the same analysis but for the baseline Cu∥NVP cell. The dendritic structures present on the surface of the Cu collector for Cu∥NVP cell were not removed after the stripping cycle, providing a direct explanation for the 30% CE measured at cycle one.

FIGS. 39A-39B show Nyquist plots of electrochemical impedance spectroscopy of NST∥NVP (FIG. 39A) and Cu∥NVP cells (FIG. 39B) at different charge-discharge states. Both cells were tested at 1 C in 1 M NaPF₆ in the G2 electrolyte.

FIGS. 40A-40H show representative structures of Na₄ or Na₅ cluster binding on bcc Na, fcc Na₂Te, and fcc NST surfaces: Na₄ cluster (FIG. 40A) and Na₅ cluster on (110) bcc Na surface (FIG. 40B), Na₄ cluster (FIG. 40C) and Na₅ cluster on (110) fcc Na₂Te surface (FIG. 40D), Na₄ cluster (FIG. 40E) and Na₅ cluster on (100) fcc NST surface (FIG. 40F), Na₄ cluster (FIG. 40G) and Na₅ cluster (FIG. 40H) on (200) fcc Cu surface. Color scheme: Na (purple), Te (yellow), Sb (brown), Cu (green) and Na in binding site (orange).

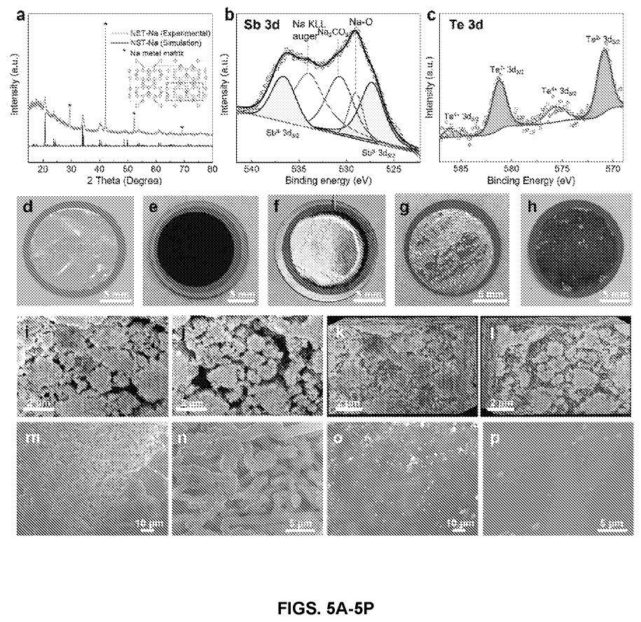

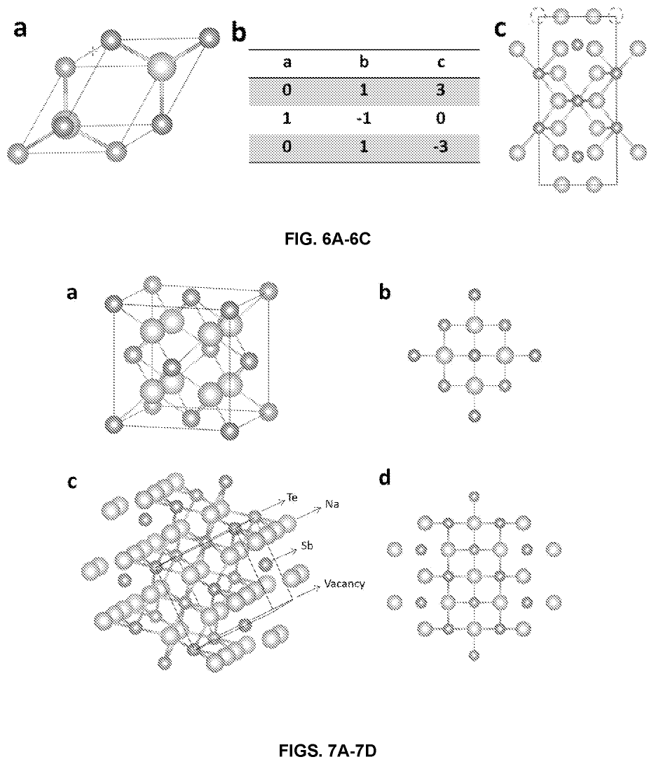

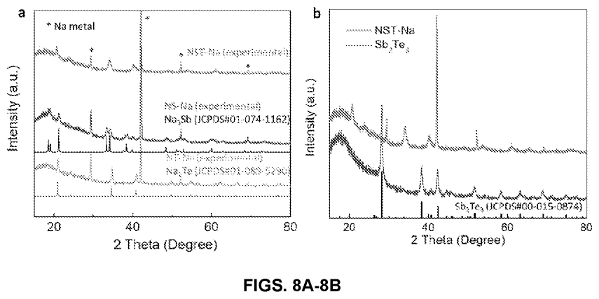

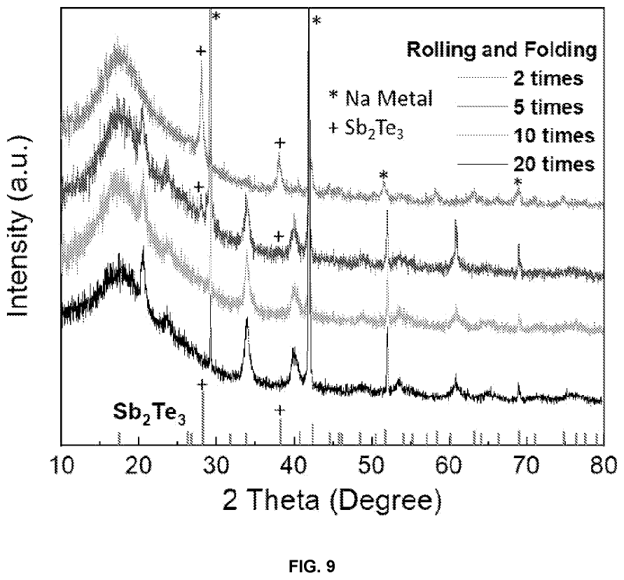

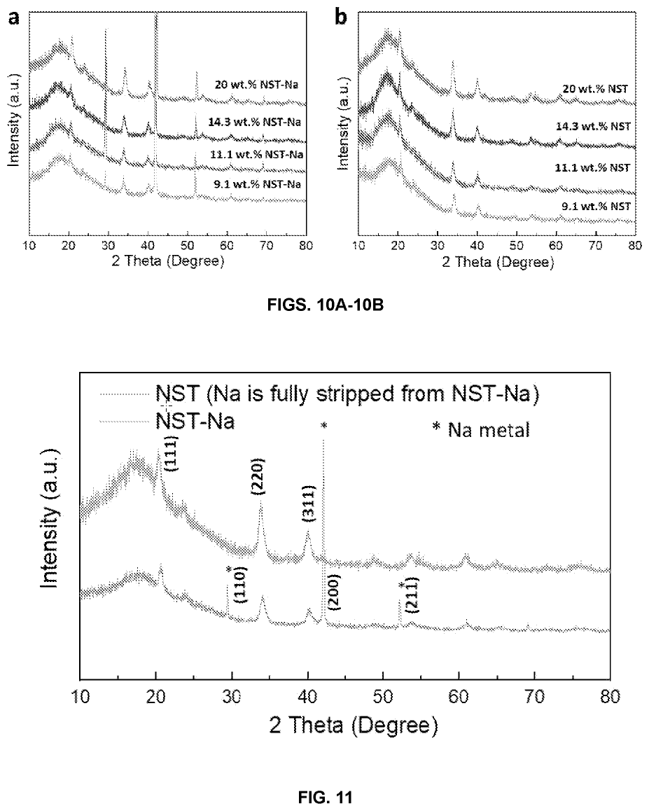

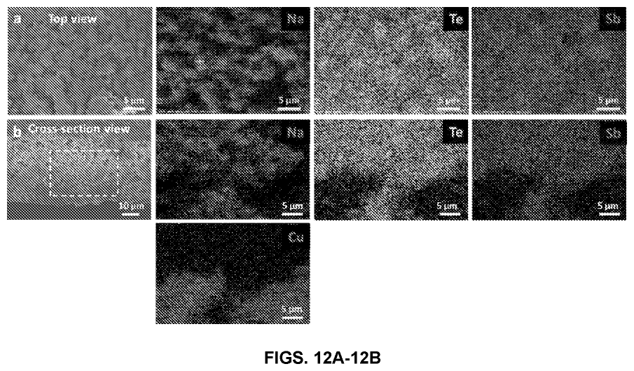

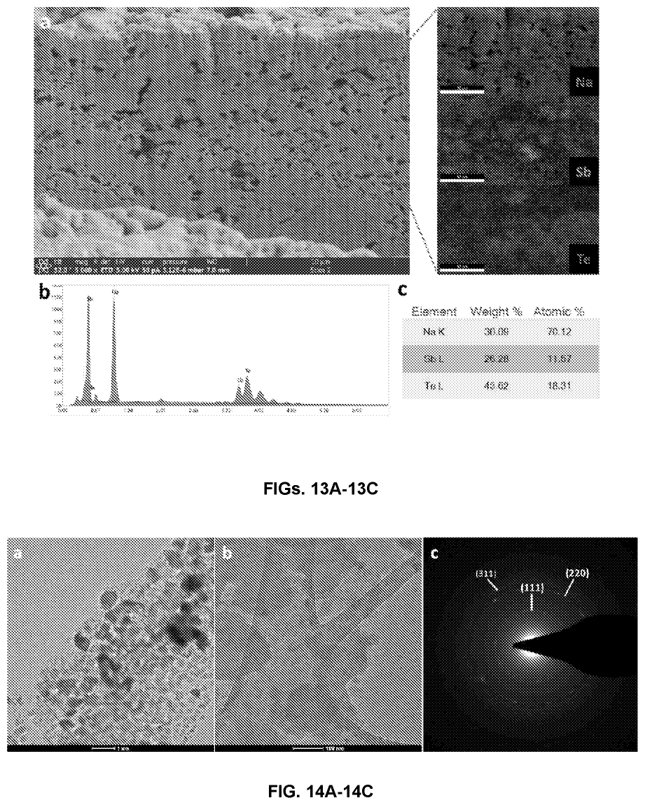

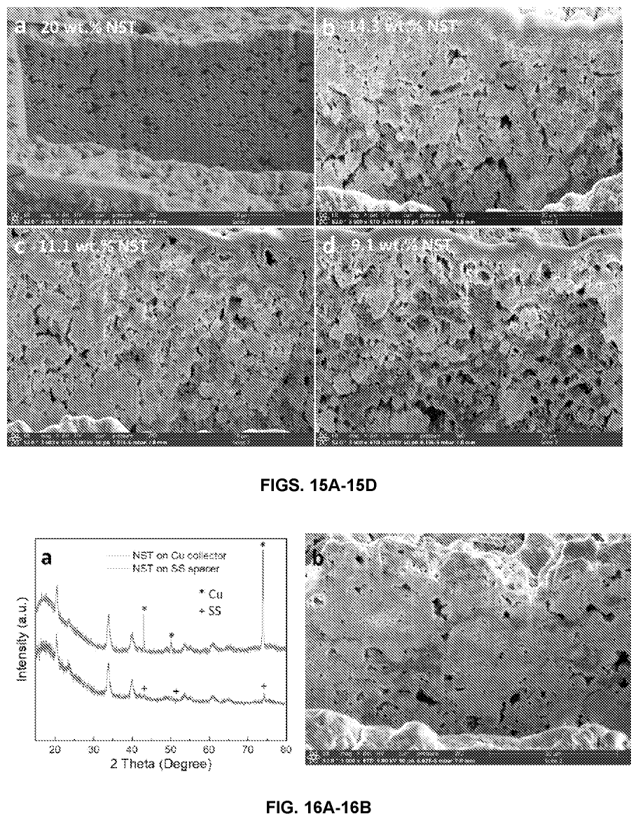

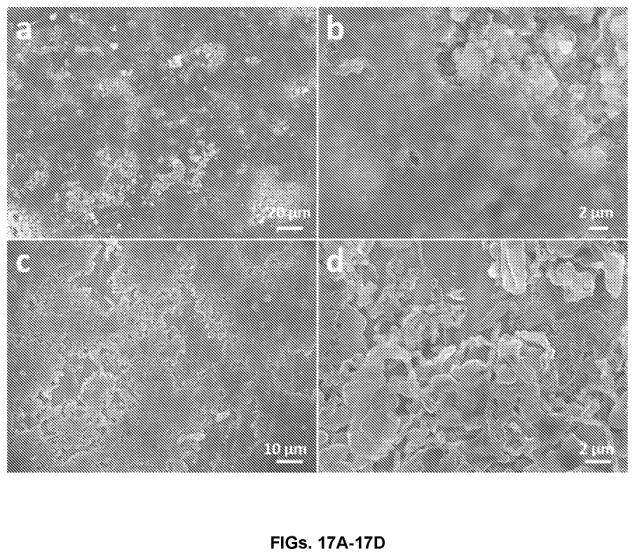

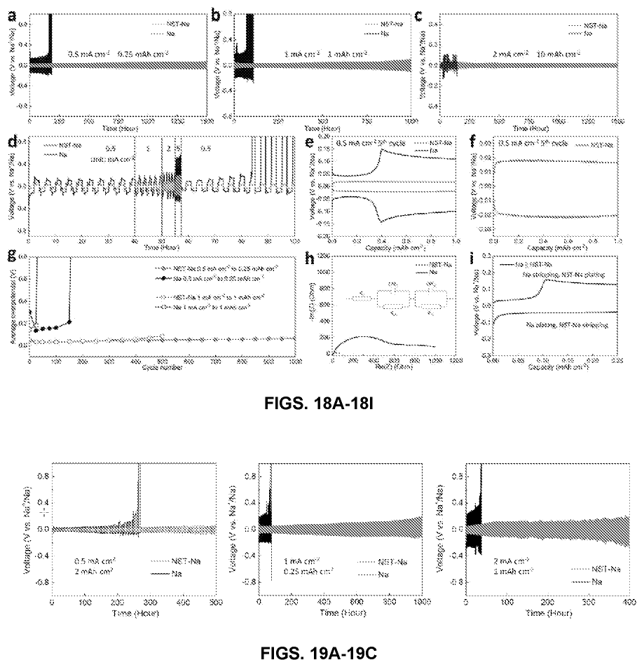

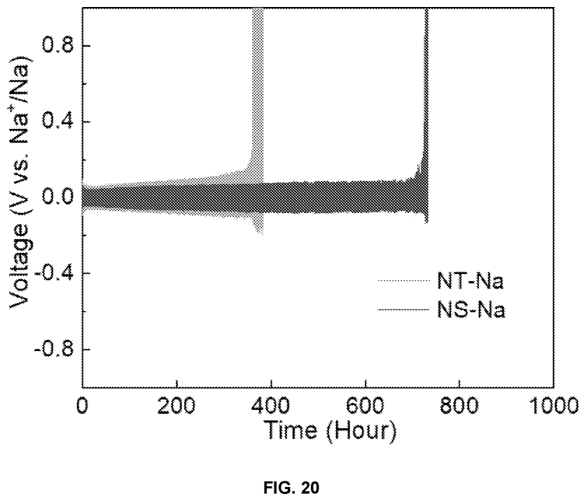

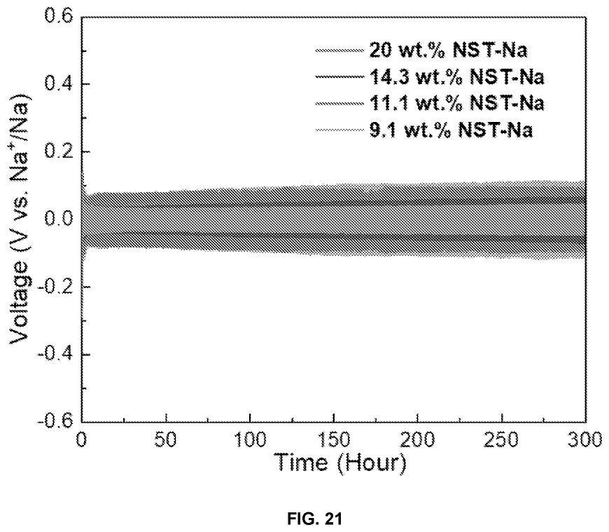

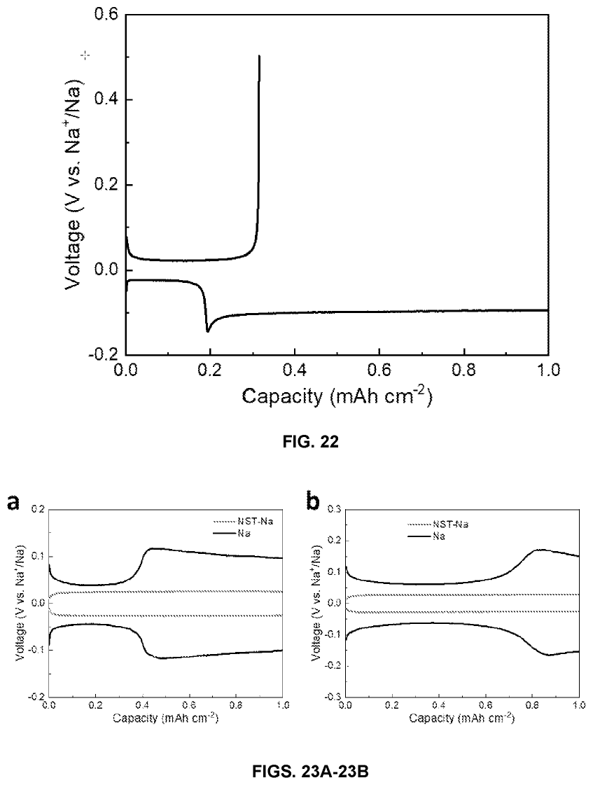

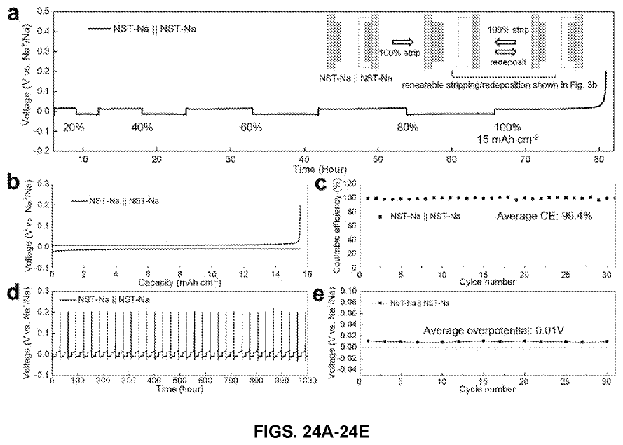

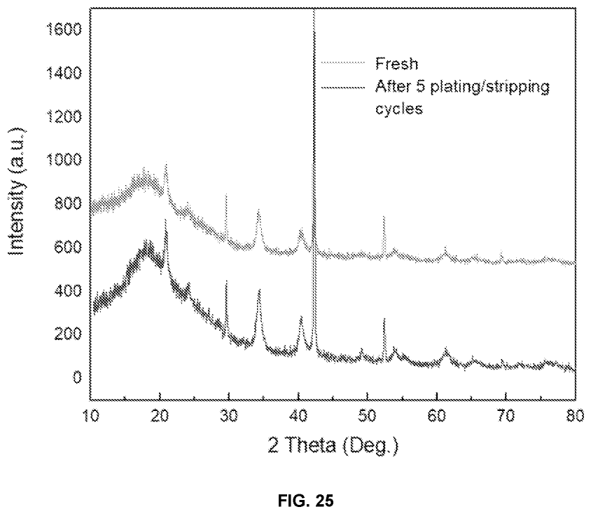

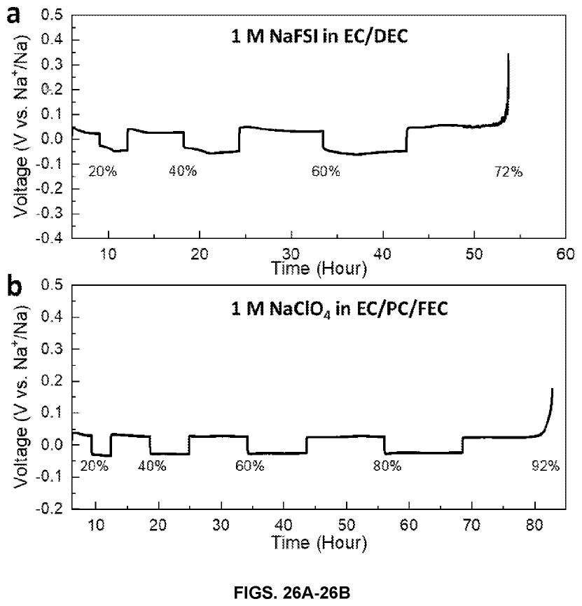

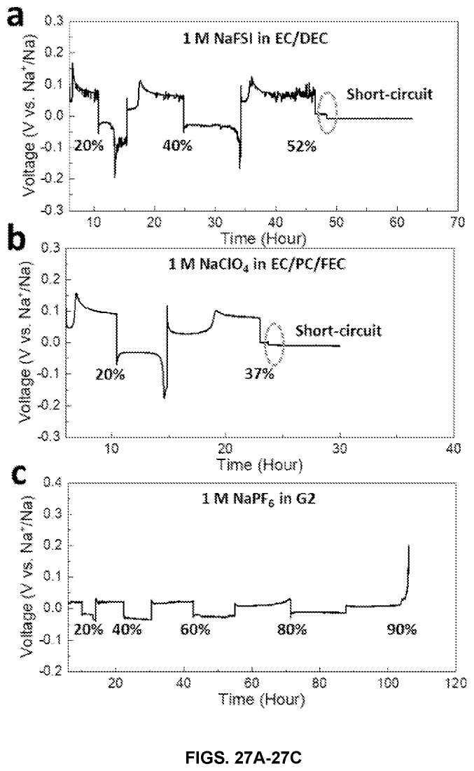

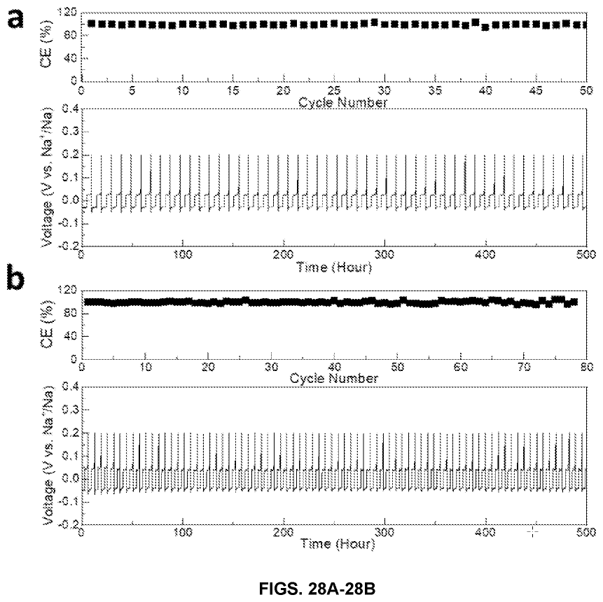

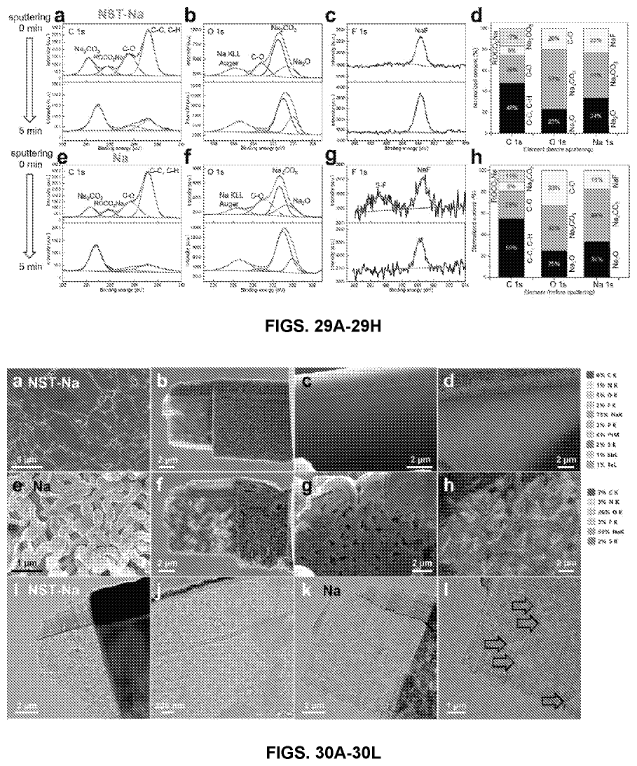

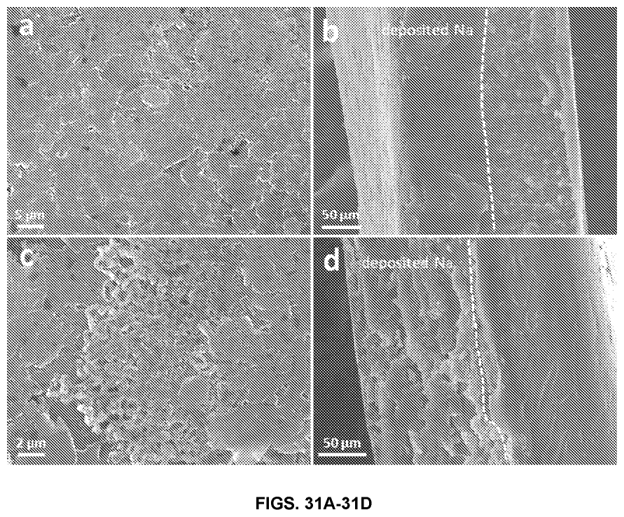

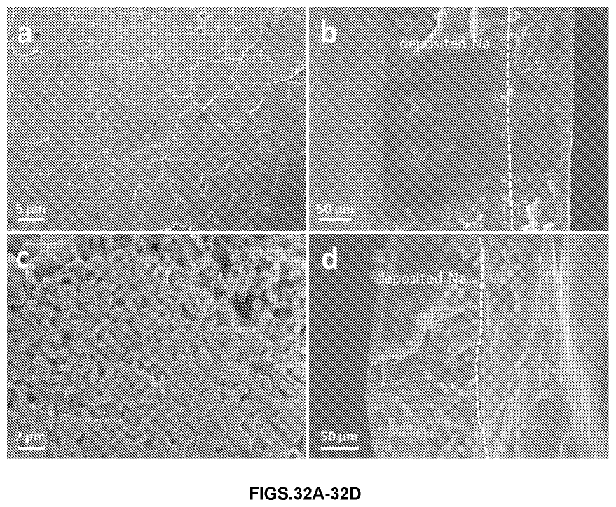

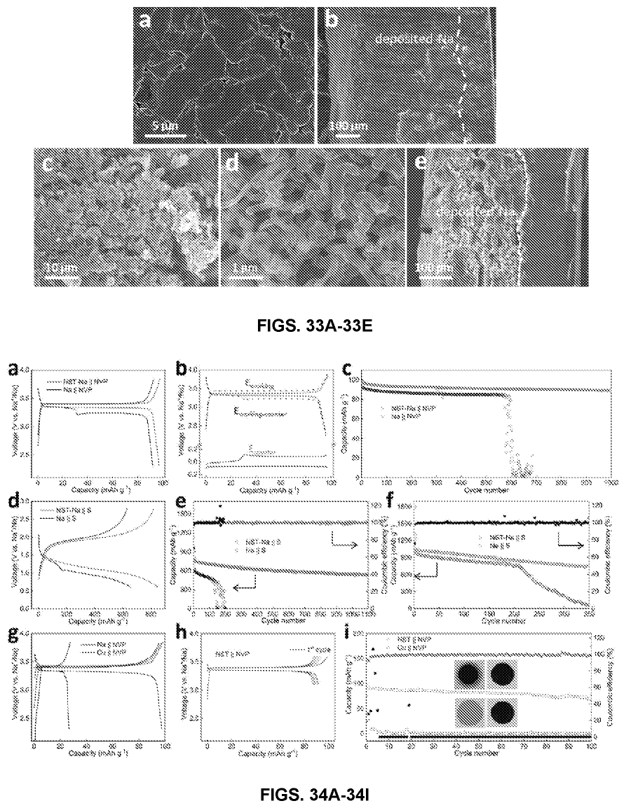

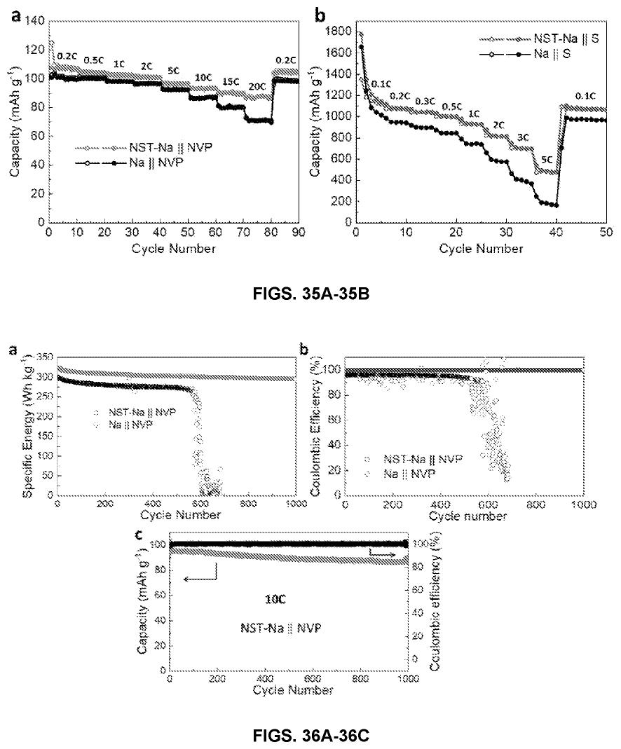

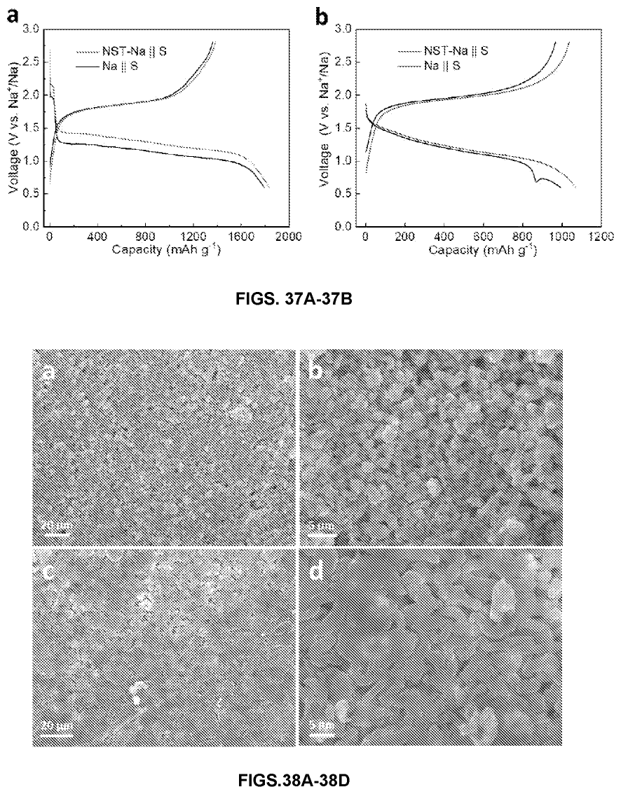

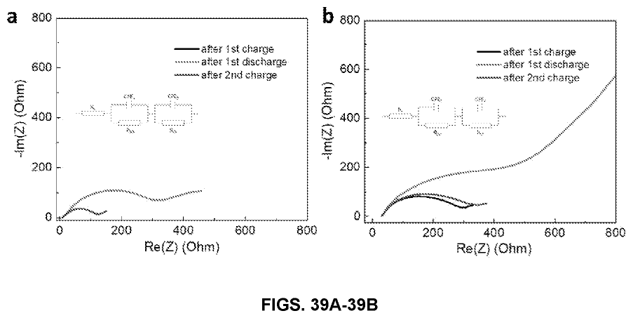

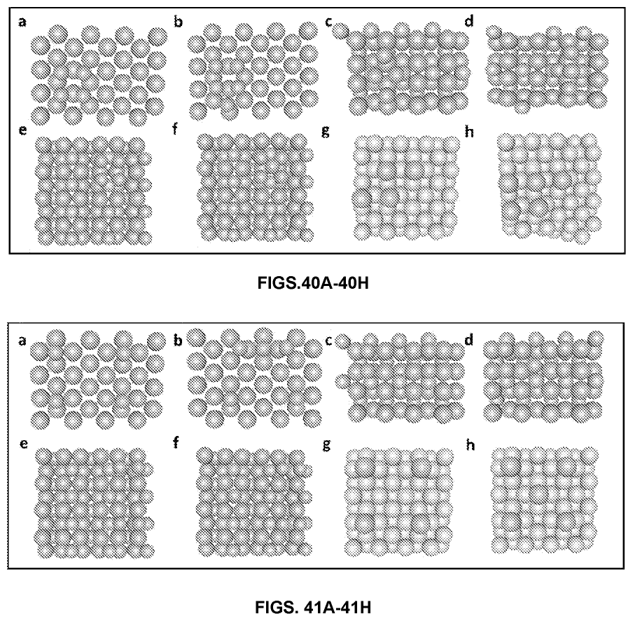

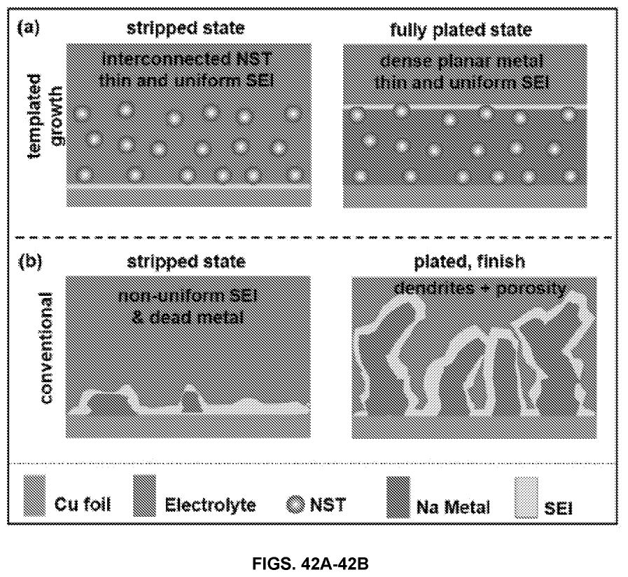

FIGS. 41A-41H show representative structures of 4 or 5 individual Na atoms binding on bcc Na, fcc Na₂Te, and fcc NST surfaces: 4 Na atoms (FIG. 41A) and 5 Na atoms (FIG. 41B) on (110) bcc Na surface, 4 Na atoms (FIG. 41C) and 5 Na atoms (FIG. 41D) on (110) fcc Na₂Te surface, 4 Na atoms (FIG. 41E) and 5 Na atoms (FIG. 41F) on (100) fcc NST surface, 4 Na atoms (FIG. 40G) and 5 Na atoms (FIG. 40H) on (200) fcc Cu surface. Color scheme: Na (purple), Te (yellow), Sb (brown), Cu (green), and Na in binding site (orange).

FIGS. 42A-42B show NST enhancement effect on the plating and stripping behavior. FIG. 42A shows the role of NST on uniform plating/stripping of Na metal, and FIG. 42B shows a baseline Cu foil with coarse and irregular SEI from the onset and the formation of dead metal upon stripping.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “an element” includes two or more such elements, and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Ionophilic Template

In some aspects disclosed herein is an ionophilic template comprising a microscopic array having a formula of Mₐ(SbₓTe_{y}Vac_{z}). In certain aspects, an M comprises one or more of Na, Li, K, Mg, Ca, Al, Zn, or alloys thereof. In yet other aspects, a Vac refers to vacancies present in a lattice of the microscopic array, where a is 0≤a≤100. In such aspects, a can be, for example, 0, 0.1, 0.5, 0.7, 1, 1.2, 1.5, 1.7, 2, 2.2, 2.5, 2.7, 3, 3.5, 4, 4.5, 5, 5.5, 6, 6.5, 7, 7.5, 8, 8.5, 9, 9.5, 10, 20, 30, 40, 50, 60, 70, 80, 90, and 100.

In yet still, further aspects x is 0≤x≤1, including exemplary values of 0, 0.1, 0.2, 0.3, 0.4, 0.5, 0.6, 0.7, 0.8, 0.9, 0.99 and 1. In still further aspects, y is 0≤y≤1, including exemplary values of 0, 0.1, 0.2, 0.3, 0.4, 0.5, 0.6, 0.7, 0.8, 0.9, 0.99, and 1. While in still further aspects, z is 0≤z≤1, including exemplary values of 0, 0.1, 0.2, 0.3, 0.4, 0.5, 0.6, 0.7, 0.8, 0.9, 0.99, and 1.

It is understood that a, x, y, and z, can have any value between any two foregoing values. For example, x can be 0≤x≤0.35, including exemplary values of 0, 0.01, 0.05, 0.1, 0.15, 0.2, 0.25, 0.3, 0.33, 0.34, and 0.35. In still further exemplary aspects, y can be 0≤y≤0.7, including exemplary values of 0, 0.01, 0.05, 0.1, 0.15, 0.2, 0.25, 0.3, 0.35, 0.4, 0.45, 0.5, 0.55, 0.6, 0.65, 0.69, and 0.7. In yet still further aspects, z can be 0≤z≤0.2, including exemplary values of about 0, 0.01, 0.05, 0.07, 0.1, 0.11, 0.12, 0.13, 0.14, 0.15, 0.16, 0.17, 0.18, 0.19, and 0.2.

In yet still further aspects, the microscopic array disclosed herein is dispersed within a metal comprising the M. While in still further aspects, the ionophilic template can behave as a support material for a metal anode.

In still further aspects, a ratio of Sb to an M can be any ratio that would provide the desired results. In some aspects, a ratio of Sb to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In yet still further aspects, a ratio of Te to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In still further aspects, a ratio of Sb to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %, and wherein a ratio of Te to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In still further aspects, the disclosed herein ionophilic template is configured to provide a depth-of-discharge of the metal anode from about 1% to 100%, including exemplary values of about 5%, 10%, 15%, 20%, 25%, 30%, 35%, 40%, 45%, 50%, 60%, 65%, 75%, about 80%, about 85%, about 90%, and about 95%.

In still further aspects, the ionophilic template, disclosed herein, is configured to provide a coulombic efficiency of the metal anode greater than about 50%, greater than about 55%, greater than about 60%, greater than about 65%, greater than about 70%, greater than about 75%, greater than about 80%, greater than about 85%, greater than about 90%, greater than about 95%, or greater than about 99% at a current density from about 0.1 mA cm⁻² to about 10 mA cm⁻², including exemplary values of about 0.15 mA cm⁻², about 0.2 mA cm⁻², about 0.25 mA cm⁻², about 0.3 mA cm⁻², about 0.35 mA cm⁻², about 0.40 mA cm⁻², about 0.45 mA cm⁻², about 0.5 mA cm-2, about 0.55 mA cm⁻², about 0.6 mA cm⁻², about 0.65 mA cm⁻², about 0.7 mA cm⁻², about 0.75 mA cm⁻², about 0.8 mA cm⁻², about 0.85 mA cm⁻², about 0.9 mA cm⁻² about 0.95 mA cm⁻², about 1 mA cm⁻², about 1.5 mA cm⁻², about 2 mA cm⁻², about 2.5 mA cm⁻², about 3 mA cm⁻², about 3.5 mA cm⁻², about 4 mA cm⁻², about 4.5 mA cm⁻², about 5.5 mA cm⁻², about 6 mA cm⁻², about 6.5 mA cm⁻², about 7 mA cm⁻², about 7.5 mA cm⁻², about 8 mA cm⁻², about 8.5 mA cm⁻², about 9 mA cm⁻², and about 9.5 mA cm⁻².

In some aspects, the ionophilic template is configured to exhibit substantially stable cycling profiles for greater than about 1 hour, about 2 hours, greater than about 5 hours, greater than about 10 hours, greater than about 50 hours, greater than about 100 hours, greater than about 200 hours, greater than about 300 hours, greater than about 400 hours, greater than about 500 hours, greater than about 600 hours, greater than about 700 hours, greater than about 800 hours, greater than about 900 hours, greater than about 1,000 hours, greater than about 1,100 hours, greater than about 1,200 hours, greater than about 1,300 hours, greater than about 1,400 hours, greater than about 1,500 hours, greater than about 1,600 hours, greater than about 1,700 hours, greater than about 1,800 hours, greater than about 1,900 hours, or greater than about 2,000 hours.

In yet other aspects, the ionophilic template is configured to exhibit substantially stable cycling profiles up to about 600 hours, up to about 700 hours, up to about 800 hours, up to about 900 hours, up to about 1,000 hours, up to about 1,100 hours, up to about 1,200 hours, up to about 1,300 hours, up to about 1,400 hours, up to about 1,500 hours, up to about 1,600 hours, up to about 1,700 hours, up to about 1,800 hours, up to about 1,900 hours, up to about 2,000 hours, up to about 2,100 hours, up to about 2,200 hours, up to about 2,300 hours, up to about 2,400 hours, up to about 2,500 hours, up to about 2,600 hours, up to about 2,700 hours, up to about 2,800 hours, up to about 2,900 hours, up to about 3,000 hours, hours, up to about 5,000 hours, up to about 10,000 hours, up to about 20,000 hours, up to about 30,000 hours, up to about 40,000 hours, up to about 50,000 hours, up to about 60,000 hours, up to about 70,000 hours, up to about 80,000 hours, up to about 90,000 hours, or up to about 100,000 hours. It is understood, however, that the ionophilic template can be configured to exhibit substantially stable cycling profiles for up to about 5 years, up to about 10 years, and up to 15 years or greater.

In yet still further aspects, the ionophilic template can be prepared by any methods known in the art and applicable to the desired applications. In some aspects, the ionophilic templated can be prepared by metallurgical processing, thin film deposition, wet and dry processing, chemical and electrochemical dealloying, spin coating, spray drying, thermal and/or hydrothermal processing.

### Electrochemical Cell

Also disclosed herein is an electrochemical cell. In such aspects, the electrochemical cell can comprise a) a support material for a metal anode comprising an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and b) an electrolyte.

In such exemplary aspects, a can be 0≤a≤100, for example, 0, 0.1, 0.5, 0.7, 1, 1.2, 1.5, 1.7, 2, 2.2, 2.5, 2.7, 3, 3.5, 4, 4.5, 5, 5.5, 6, 6.5, 7, 7.5, 8, 8.5, 9, 9.5, 10, 20, 30, 40, 50, 60, 70, 80, 90, and 100. In yet still further aspects x is 0<x≤1, including exemplary values of 0, 0.1, 0.2, 0.3, 0.4, 0.5, 0.6, 0.7, 0.8, 0.9, 0.99 and 1. In still further aspects, y is 0≤y≤1, including exemplary values of 0, 0.1, 0.2, 0.3, 0.4, 0.5, 0.6, 0.7, 0.8, 0.9, 0.99, and 1. While in still further aspects, z is 0≤z≤1, including exemplary values of 0, 0.1, 0.2, 0.3, 0.4, 0.5, 0.6, 0.7, 0.8, 0.9, 0.99, and 1.

It is understood that a, x, y, and z, can have any value between any two foregoing values. For example, x can be 0≤x≤0.35, including exemplary values of 0, 0.01, 0.05, 0.1, 0.15, 0.2, 0.25, 0.3, 0.33, 0.34, and 0.35. In still further exemplary aspects, y can be 0≤y≤0.7, including exemplary values of 0, 0.01, 0.05, 0.1, 0.15, 0.2, 0.25, 0.3, 0.35, 0.4, 0.45, 0.5, 0.55, 0.6, 0.65, 0.69, and 0.7. In yet still further aspects, z can be 0≤z≤0.2, including exemplary values of about 0, 0.01, 0.05, 0.07, 0.1, 0.11, 0.12, 0.13, 0.14, 0.15, 0.16, 0.17, 0.18, 0.19, and 0.2.

In still further aspects, a ratio of Sb to an M can be any ratio that would provide for the desired results. In some aspects, a ratio of Sb to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In yet still further aspects, a ratio of Te to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In still further aspects, a ratio of Sb to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %, and wherein a ratio of Te to the M is from greater than 0 to 100 wt %, including exemplary values of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, and about 99 wt %.

In still further aspects, any suitable for the desired purpose electrolytes can be utilized. In some aspects, the electrolyte can comprise a salt and a non-aqueous solvent. In some exemplary aspects, the salt that is present in the electrolyte can comprise any salt commonly used in the batteries. In still further aspects, the salt can comprise a potassium, sodium, lithium, magnesium, calcium, or aluminum salt of bis(fluorosulfonyl) imide, trifluoromethanesulfonate, bis(trifluoromethane)sulfonimide, difluoro(oxalato)borate, perchlorate, tetrafluoroborate, hexafluorophosphate, hexafluroarsenate, a potassium, sodium, or lithium salt aluminum tetrachloride, boron tetrachloride iodide, chlorate, borate, iodate, or a combination thereof.

While in other aspects, the non-aqueous electrolyte can comprise dioxane, ethylene carbonate, dimethyl carbonate, diethyl carbonate, ethyl methyl carbonate, polyoxylene, fluoroethylene carbonate, propylene carbonate, N-methyl acetamide, N-Methyl-2-pyrrolidone, acetonitrile, symmetric sulfone, sulfolane, polyethylene glycol, 1,3-dioxolane, glymes, siloxane, ethylene oxide grafted sulfolane, toluene, dimethylbenzene, dimethylformamide, dimethyl sulfoxide, tetrahydrofuran, or a combination thereof. If more than one solvent is present, such electrolytes can comprise solvents in any ratio to each other that can provide for the desired results.

In yet some exemplary and unlimiting aspects, the glymes can comprise diglyme, tetraglyme, or a combination thereof.

Ain certain aspects, the electrolytes can also be solid electrolytes. In still further aspects, the solid electrolyte can comprise sulfide compounds, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof. If the electrolyte is polymer-based, such electrolytes can further comprise an alkali metal, an alkaline-earth metal salt, or a combination thereof.

In still further aspects, the alkali metal salt or alkaline-earth metal salt present in the solid electrolyte can comprise any of the alkali metal salt that is suitable for the desired application. It is also understood that the alkali metal salt or alkaline-earth metal salt composition can be defined by the final use. For example, if the solid electrolyte is designed for use in a lithium electrochemical cell, the alkali metal salt can comprise Li cations. However, it is also understood that if the solid electrolyte is designed for use in sodium or potassium electrochemical cells, the alkali metal salt can comprise Na or K cations and the like.

In still further aspects, the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPF₆), lithium hexafluroarsenate (LiAsF₆), lithium bis(fluorosulfonyl)imide (LiFSI), lithium aluminum tetrachloride (LiAlCl₄), lithium boron tetrachloride (LiBCl₄), lithium iodide (Lil), lithium chlorate (LiClO₃), LiBrO₃, LiIO₃, or a combination thereof. It is understood that similar salts of K and Na can also be utilized if desired.

In still further aspects, the polymer can comprise poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof. In still further aspects, the polymer can comprise a mixture of the polymers, for example, and without limitations, such as a cross-linked polymer blend comprising PEO or PEO-PVDF may be selected.

In still further aspects, the solid electrolyte can further comprise a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof. While in other aspects, if the anode material is K or Na, the solid electrolytes disclosed above can comprise Na or K incorporated within. For example, and without limitations, it can be a sodium phosphorus sulfide electrolyte or a potassium phosphorus sulfide electrolyte

In further aspects, the electrolyte can be a hybrid liquid-solid electrolyte. In such aspects, any of the disclosed above liquid electrolytes (electrolytes comprising the disclosed above salts and non-aqueous solvents) and any of the disclosed above solid electrolytes can be combined to form the hybrid liquid-solid electrolyte.

In still further aspects, the support material disclosed above can be disposed on a substrate. In such aspects, the substrate comprises stainless steel, aluminum, titanium, tungsten, copper, or a combination thereof. Yet, in other aspects, any known in the art battery support materials can be used. In certain aspects, the support material can be a polymer. Again, any polymers known in the art of batteries can be utilized for this purpose.

In still further aspects, the electrochemical cell disclosed herein can be a battery. In some aspects, the battery is a primary battery. While in other aspects, the battery is a secondary battery. In such exemplary aspects, the battery can be a metal battery or an ion-metal battery.

In aspects disclosed herein, the anode can comprise ions and/or metals of potassium, sodium, lithium, or a combination thereof.

The electrochemical cell of the present disclosure can further comprise a cathode material. It is understood that any known in the art cathode materials that can be useful for the desired purpose can be utilized. In some aspects, the cathode can be a metal cathode or composite cathode.

If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li or K or Na, or a combination thereof.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode can also comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode. In still further aspects, the cathode can comprise KFe^{II}Fe^{III}(CN)₆, NaFe^{II}Fe^{III}(CN)₆, Na₃V₂(PO₄)₃, LiFePO₄, Li(NiCoMn)O₂, or any combination thereof. In yet still further aspects, the cathode material can also comprise a poly(ethylene oxide), cellulose, carboxymethylcellulose (CMC), and a polytetrafluoroethylene (PTFE), styrene-butadiene rubber (SBR), or a polyvinylidene fluoride binder.

In still further aspects, wherein the cell disclosed herein can exhibit a substantially stable plating and stripping cycling for at least about 1 hour, at least about 2 hours, at least about 5 hours, at least about 10 hours, at least about 50 hours, at least about 100 hours, at least about 200 hours, at least about 300 hours, at least about t 400 hours, at least about 500 hours, at least about 600 hours, at least about 700 hours, at least about 800 hours, at least about 900 hours, at least about 1,000 hours, at least about 1,100 hours, at least about 1,200 hours, at least about 1,300 hours, at least about 1,400 hours, at least about 1,500 hours, at least about 1,600 hours, at least about 1,700 hours, at least about 1,800 hours, at least about 1,900 hours, at least about 2,000 hours at a current density from about 0.1 mA cm⁻² to about 10 mA cm⁻², including exemplary values of about 0.15 mA cm⁻², about 0.2 mA cm⁻², about 0.25 mA cm⁻², about 0.3 mA cm⁻², about 0.35 mA cm⁻², about 0.40 mA cm⁻² about 0.45 mA cm⁻², about 0.5 mA cm⁻², about 0.55 mA cm⁻², about 0.6 mA cm⁻² about 0.65 mA cm⁻², about 0.7 mA cm⁻², about 0.75 mA cm⁻², about 0.8 mA cm⁻² about 0.85 mA cm⁻², about 0.9 mA cm⁻², about 0.95 mA cm⁻², about 1 mA cm⁻², about 1.5 mA cm⁻², about 2 mA cm⁻², about 2.5 mA cm⁻², about 3 mA cm⁻², about 3.5 mA cm-2, about 4 mA cm⁻², about 4.5 mA cm⁻², about 5.5 mA cm⁻², about 6 mA cm⁻², about 6.5 mA cm⁻², about 7 mA cm⁻², about 7.5 mA cm⁻², about 8 mA cm⁻², about 8.5 mA cm⁻², about 9 mA cm⁻², and about 9.5 mA cm⁻².

In still further aspects, the cell exhibits substantially stable plating and stripping cycling for up to about 600 hours, up to about 700 hours, up to about 800 hours, up to about 900 hours, up to about 1,000 hours, up to about 1,100 hours, up to about 1,200 hours, up to about 1,300 hours, up to about 1,400 hours, up to about 1,500 hours, up to about 1,600 hours, up to about 1,700 hours, up to about 1,800 hours, up to about 1,900 hours, up to about 2,000 hours, up to about 2,100 hours, up to about 2,200 hours, up to about 2,300 hours, up to about 2,400 hours, up to about 2,500 hours, up to about 2,600 hours, up to about 2,700 hours, up to about 2,800 hours, up to about 2,900 hours, up to about 3,000 hours, hours, up to about 5,000 hours, up to about 10,000 hours, up to about 20,000 hours, up to about 30,000 hours, up to about 40,000 hours, up to about 50,000 hours, up to about 60,000 hours, up to about 70,000 hours, up to about 80,000 hours, up to about 90,000 hours, or up to about 100,000 hours. It is understood, however, that the electrochemical cell can be configured to exhibit substantially stable cycling profiles for up to about 5 years, up to about 10 years, and up to 15 years or greater.

In yet still further aspects, the electrochemical cells described herein can exhibit a coulombic efficiency of greater than about 50%, greater than about 55%, greater than about 60%, greater than about 65%, greater than about 70%, greater than about 75%, greater than about 80%, greater than about 85%, greater than about 90%, greater than about 95%, or greater than about 99%.

In still further aspects, the electrochemical cells described herein can exhibit a reversible capacity of up to about 100 mAh/g, up to about 200 mAh/g, up to about 300 mAh/g, up to about 400 mAh/g, up to about 500 mAh/g, up to about 600 mAh/g, up to about 700 mAh/g, up to about 800 mAh/g, up to about 900 mAh/g, up to about 1,000 mAh/g.

In still further aspects, the electrochemical cells described herein can exhibit specific energy from about 1 to about 1,000 Wh/kg, including exemplary values of about 2 Wh/kg, about 5 Wh/kg, about 10 Wh/kg, about 25 Wh/kg, about 50 Wh/kg, about 75 Wh/kg, about 100 Wh/kg, about 200 Wh/kg, about 300 Wh/kg, about 400 Wh/kg, about 500 Wh/kg, about 600 Wh/kg, about 700 Wh/kg, about 800 Wh/kg, and about 900 Wh/kg after about 1000 cycles at a specific power of about 1 to about 10,000 W/kg, including exemplary values of 2 W/kg, about 5 W/kg, about 10 W/kg, about 25 W/kg, about 50 W/kg, about 75 W/kg, about 100 W/kg, about 200 W/kg, about 300 W/kg, about 400 W/kg, about 500 W/kg, about 600 W/kg, about 700 W/kg, about 800 W/kg, about 900 W/kg, about 1,000 W/kg, about 2,000 W/kg, about 3,000 W/kg, about 4,000 W/kg, about 5,000 W/kg, about 6,000 W/kg, about 7,000 W/kg, about 8,000 W/kg, and about 9,000 W/kg.

In yet still further aspects, substantially no dendrites are formed during a plating cycle.

In still further aspects, the electrochemical cell is configured to operate in a temperature range from about 20° C. up to about 60° C., including exemplary values of about 25° C., about 30° C., about 35° C., about 40° C., about 45° C., about 50° C., and about 55° C. It is understood that a time window for the cell operation can be dependent on the operating conditions, such as operating current density and areal capacity.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series. METHODS

Also disclosed herein are the methods of making the disclosed herein ionophilic templates. In such aspects, the methods comprise disposing an amount of Sb₂Te₃ within a metal M to form a microscopic array having a formula of Mₐ(SbₓTe_{y}Vac_{z}), wherein the M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1. It is understood that the disclosed methods are directed at making any of the disclosed above ionophilic templates.

In certain aspects, the step of disposing comprises incorporating Sb₂Te₃ within the metal M by a rolling-folding process. Yet, in other aspects, the step of disposing comprises depositing a thin film of Sb₂Te₃ on the metal M and thermally incorporating Sb₂Te₃ within the metal M. In yet still further aspects, the step of disposing comprises chemical and electrochemical dealloying, spin coating, spray drying, thermal and/or hydrothermal or any combination thereof.

Still, further aspects, the methods disclosed herein comprise forming any of the disclosed above batteries. In certain aspects, the methods comprise providing any of the disclosed above ionophilic templates and any of the disclosed above electrolytes. Such methods comprise using the ionophilic templates as a support material for anodes. In some aspects, such templates can be disposed on the substrates as disclosed above.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Electrode Preparation

Sodium-antimony-telluride “NST-Na” was prepared through a rolling-folding process. Typically, 25 mg Sb₂Te₃ powder (Sigma-Aldrich, 99%) was added onto a 100 mg sheet of sodium metal (Sigma-Aldrich, 99.9%), giving an initial weight ratio of 1:4. The sodium with Sb₂Te₃ powder on its surface was mechanically rolled into a flat sheet, the processes being conducted inside a glove box. The sheet was then folded in half and rolled into a flat sheet again. After repeating the rolling-folding process for 20 iterations, the final 150-micron thick NST-Na electrode was obtained. As a baseline, NST-Na composites with Sb₂Te₃ to Na starting ratios of 1:6, 1:8, and 1:10 were also fabricated. The starting amount of Sb₂Te₃ was kept constant at 25 mg, while the Na sheet size was increased to correspond to 150 m, 200 mg, and 250 mg, respectively. The same rolling and folding process was then employed to fabricate these lower NST loading electrodes. Per FIG. 21, the NST-Na electrodes with 20 wt. % Sb₂Te₃ exhibited the overall most favorable electrochemical performance. Therefore all electroanalytical and analytical studies in this manuscript are based on the 20 wt. % Sb₂Te₃ specimens, unless otherwise indicated. To prepare baseline Na₂Te—Na “NT-Na” and Na₃Sb—Na “NS—Na” electrodes, 25 mg Te (Sigma-Aldrich, 99.8%) or 25 mg Sb powder (Sigma-Aldrich, 99.5%) was employed to fabricate the electrodes in the same manner.

An NVP (Na₃V₂(PO₄)₃) cathode was synthesized as known in the art. To obtain working cathodes, the material was mixed with a conductive carbon (Super P) and poly(vinylidene fluoride) (PVDF) binder at a weight ratio of 7:2:1 in 1-methyl-2-pyrrolidone (NMP) solvent. The slurry was then coated onto an Al foil. The electrodes were vacuum dried at 80° C. for 12 h and cut into disks. The mass loading of NVP is around 2.5 mg cm⁻². A sulfur-based cathode was synthesized using the following approach: Carbon precursors were prepared by a polymerization method per reference. This was followed by annealing at 650° C. for 5 h in an Ar atmosphere and KOH activation at 700° C. for 2 h under a continuous Ar flow. The obtained carbon host was neutralized with 2 M HCl and then washed with distilled water, after which it was dried in an oven overnight and collected.

To prepare the S@carbon cathode, the as-synthesized porous carbon and sulfur powder were thoroughly mixed in a mass ratio of 1:1 and then sealed in a glass ampoule under a vacuum. Sulfur impregnation was conducted at 155° C. for 12 h first, and then at 300° C. for 2 h. A slurry of 7:2:1 active material, carbon black (Super-P), and CMC binder were dissolved in distilled water and coated onto an Al foil. Electrodes were obtained after drying at 50° C. overnight in a vacuum oven, and the typical mass loading of active material on each electrode is around 1.5 mg cm⁻².

### Electrochemical Analysis

Experiments were conducted at room temperature, using a potentiostat (VMP3, Bio-Logic) or a battery tester (LAND CT-2001A). CR2032-type coin cells were used for electrochemical characterization unless otherwise indicated. The cells were assembled in an Ar-filled glovebox (<0.1 ppm of water and oxygen). For symmetric cells, two identical electrodes were employed, NST-Na∥NST-Na or baseline Na∥Na. For asymmetric cells, NST-Na, NST (with Na fully stripped out), or baseline Na were employed for working and opposing electrodes. The specific configuration details for each data set are provided in the main text. For full battery cells, NVP or S-based cathodes were tested against NST-Na or baseline Na. The specific energy E (Wh kg⁻¹) is calculated according to the equation:

$$E = \frac{I}{m} {\int }_{0}^{t} V ( t ) dt$$

where t is the discharge time (h), l is the constant discharge current (A), m is the mass of the active material (kg), and V(t) is the time-dependent voltage (V). The specific power P (W kg⁻¹) is calculated by

$$P = \frac{E}{t} .$$

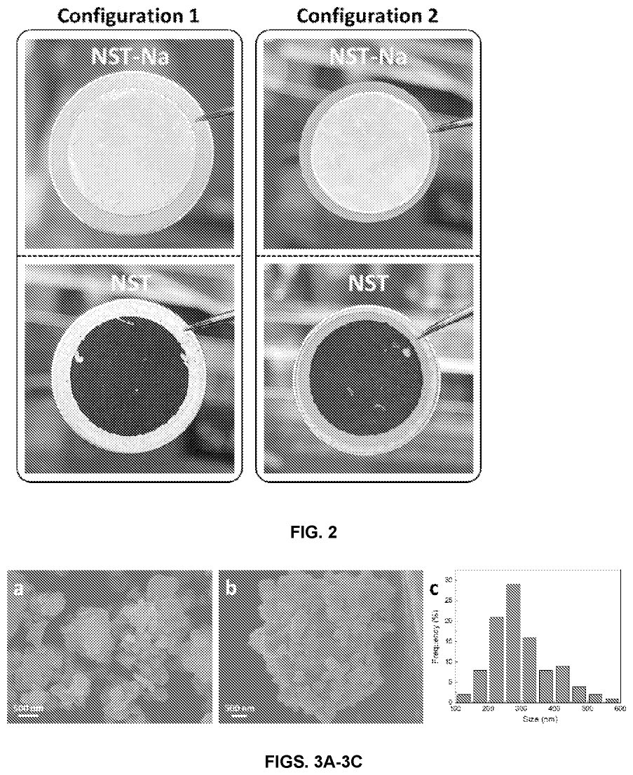

For anode-free cells, NVP cathodes were tested against NST or bare Cu collectors. For the symmetric and asymmetric metal cells, the plated/stripped area normalized capacity per cycle is provided in the description of the results and in the figure captions. Two electrode configurations were applied during battery assembly: As shown in FIG. 2, Configuration 1 was used for all electrochemical tests, while Configuration 2 was used for post-mortem analysis. A piece of Cu foil (ϕ14 mm) was placed between the metal anode and the stainless steel (SS) spacer to facilitate exfoliation and prevent damage during sample preparation. Per FIG. 16A-16B, there is no substantial structural and morphological difference of NST after Na was extracted from NST-Na on different collectors.

Ethylene carbonate (EC), diethyl carbonate (DEC), propylene carbonate (PC), diglyme (G2), and fluoroethylene carbonate (FEC) were obtained from Sigma-Aldrich and dried over freshly activated molecular sieves (4 A, Sigma-Aldrich) for 48 h before use. Sodium bis(fluorosulfonyl)imide (NaFSI, Solvionic, 99.7%) was dried under vacuum at 100° C. for 24 h. Sodium hexafluorophosphate (NaPF₆, Sigma-Aldrich) and sodium perchloride (NaClO₄, Sigma-Aldrich) were used as received. The electrolyte solutions of 1 M NaFSI in EC/DEC (1:1, v/v), 1 M NaClO₄ in EC/PC (1:1, v/v) with 5 wt. % FEC and 1 M NaPF₆ in G2 were obtained by mixing the salts with the solvents. The solutions were kept under stirring at room temperature for 24 h until they became clear. The figure captions and the associated text describe which electrolyte was employed for a given electroanalytical and analytical experiment. For all NST analyzed by XRD, SEM, FIB, etc., electrochemical stripping of metallic Na from NST-Na was performed at 1 mA cm⁻² in 1 M NaPF₆ in G2 (unless otherwise indicated).

### Materials Characterization

Scanning electron microscopy images were collected using a field emission scanning electron microscope (FE-SEM, Hitachi S-5500) with an energy-dispersive X-ray spectrometer (EDX). Cryo-stage transmission electron microscopy (TEM) lamella sample preparation was performed on a Scios 2 Dual Beam SEM/FIB with an installed Leica VCT cryogenic stage. To preserve the beam-sensitive Na-based materials' structural integrity and reduce artifact inclusion, the sample was cooled to −150° C. The Ga⁺ FIB milling was performed with a reduced accelerating voltage of 16 keV. Final thinning was carried out using a beam current of 50 pA. TEM analysis was performed at cryogenic temperatures on an aberration-corrected Titan ETEM operating at 300 keV in a Gatan 626 cryo holder. Images were taken using a Gatan K2 direct detection camera. X-ray diffraction (XRD) was conducted on the Rigaku diffractometer with Cu Kα radiation. X-ray photoelectron spectroscopy (XPS) was performed on Kratos, Axis UltraDLD XPS system equipped with Mg Kα radiation. All cycled electrodes were extracted from disassembled cells in an Ar-filled glovebox (<0.1 ppm of H₂O and O₂) and washed by anhydrous EC/DEC or G2 (1 min and three times). The washed electrodes were vacuum-dried at room temperature for 10 min.

### Electronic Structure Calculations

The structure of the NST intermetallic and its interaction with the Na metal anode was investigated with density functional theory (DFT). DFT calculations were performed with the Vienna ab-initio Simulation Package, where the electronic exchange and correlation were modeled using the Perdew-Burke-Ernzerhof functional. The projector-augmented wave method was used to describe the core electrons; valence electrons were described with a plane wave basis set up to an energy cutoff of 300 eV. The Brillouin zone was sampled with a Monkhorst-Pack mesh (density=25 Å). Geometries that were considered converged when the force on each atom was less than 0.01 eV/A.

The intermetallic structure was generated from the primitive cell of Na₂Te with a transformation matrix shown in FIG. 6. After applying the transformation matrix shown in FIG. 6A and replacing 3 Te²⁻ with 2 Sb³⁻ and a vacancy (Vac) gives the intermetallic structure. The red dotted circles shown in the structure in FIG. 6B, are the location of the vacancy in the transformed structure. The atomic positions of Te and Sb are (0, 0, 0.667), (0.5, 0.5, 0.5), (0, 0, 0.333) and (0.5, 0.5, 0.833), (0.5, 0.5, 0.167) respectively. The lattice parameters of the optimized NST intermetallic are a=5.28 Å, b=7.32 Å, c=15.85 Å and the lattice parameters of Na₂Te without substitution are a=5.18 Å, b=7.33 Å, c=15.55 Å

### Results and Discussion

Extended details of the electrode fabrication, electrochemical analysis, characterization, and simulations are provided under the “Experimental and Simulation” section in the Supporting Information. In summary, a sodium antimony telluride inter-metallic-Na metal composite, termed “NST-Na,” was fabricated by repeated rolling and folding of antimony telluride (Sb₂Te₃) powder and Na metal inside an Ar-filled glove box (0.1 ppm H₂O and O₂ level). The 20 iterations of repeated rolling and folding resulted in the in situ formation of a metallurgical composite structure consisting of stable sodium antimony tellurium crystallites densely dispersed within an electrochemically active Na-metal matrix. As per the DFT simulation of the structure and the indexed X-ray diffraction (XRD) pattern, NST is a new ternary vacancy-rich ordered intermetallic compound Na₂(Sb_{2/6}Te_{3/6}Vac_{1/6}) based on the face-centered-cubic (fcc) Na₂Te structure. FIG. 1 illustrates the rolling and folding process, which was repeated 20 times to create a foil≈150 μm in thickness. The digital photographs show top-down and cross-sectional views of the resultant self-standing foil. The images were taken with a cell phone while the foil remained in the argon-filled glove box. It may be observed that its surface is macroscopically smooth, its shiny luster indicating minimum oxidation. FIG. 2 illustrates the two configurations employed for battery assembly and testing. Configuration 1 is NST-Na or NST (Na-metal-stripped) electrodes being supported by a standard stainless-steel (SS) coin-cell spacer. This architecture was employed for extensive electrochemical testing, e.g., cycling and rate performance.

Configuration 2 has NST-Na or NST being supported by a standard Cu current collector, which is in turn placed on the SS spacer. This configuration was employed for the targeted tests where the specimens that would undergo postmortem analytical characterization were better suited to removing the NST-Na or NST electrodes from the coin cell and separating them from the collector.

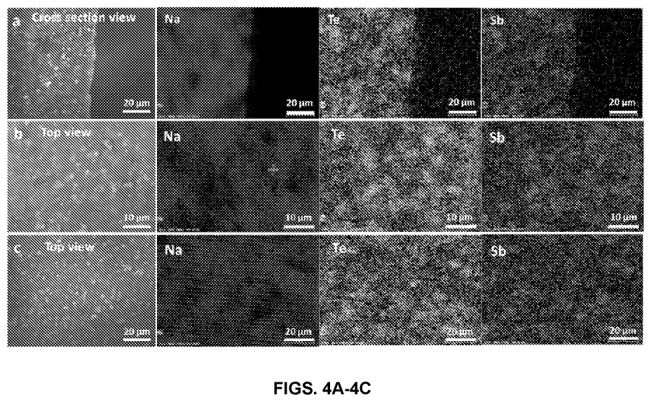

FIGS. 3A-3C show SEM images of the as-received Sb₂Te₃ powder and the associated size distribution of the particles. Using optical stereology methods (Nano Measurer), the average particle diameter was calculated to be 300 nm. It may be observed from the images that there is some agglomeration, where smaller particles are stuck to the surface of the larger ones. FIG. 4A shows a cross-sectional SEM image of the as-synthesized NST-Na, along with the associated energy-dispersive X-ray spectroscopy (EDXS) elemental maps. It may be observed that NST crystallites are densely and uniformly distributed within the Na-metal matrix. Subsequent FIB cross-sectional SEM tomography results will demonstrate that NST makes a percolated skeleton inside the Na-metal matrix. The NST crystallites are micrometers in their diameter and in their separation from each other. Top-down SEM analysis and the associated EDXS maps of the foil are shown in FIGS. 4B-4C. The images further highlight the geometrically uniform distribution of NST intermetallics within the Na-metal matrix.

The structure of NST was further analyzed by DFT calculations. The ordering of Sb and Te in the NST intermetallic was considered by enumerating many different configurations with the CASM package. Structural enumeration started from the primitive Na₂Te cell, which was optimized in terms of lattice parameters and atomic positions. The measured XRD patterns shown in FIG. 5A were directly correlated with DFT-modeled lowest energy structures. The obtained structure shown as the inset matches well with the experimental XRD pattern. Details about the structure are given in FIGS. 6 and 7. It may be observed that the unit cell of Na₂(Sb₂₆Te_{3/6}Vac_{1/6}) is 3.8% larger than the Na₂Te cell. The increased volume is due to the partial substitution of Te²⁻ (207 ppm) with a larger ionic radius Sb³⁻ (245 μm). It is noteworthy that the reaction between Na and Sb₂Te₃ through mechanical mixing is different from the electrochemical reaction of Sb₂Te₃ with Na. When the Sb₂Te₃ electrode is discharged in a cell, two equilibrium binary compounds, Na₂Te and Na₃Sb, are formed, with the reaction being reversible. As will be demonstrated, the Na₂(Sb_{2/6}Te_{3/6}Vac_{1/6}) intermetallic does not decompose upon charging.

X-ray photoelectron spectroscopy (XPS) was carried out to investigate the chemical valences of Sb and Te in the composite. FIG. 5B shows the high-resolution Sb 3d spectrum. The Sb 3d spectrum overlaps with O 1s and Na Auger spectra. The Sb³⁻3d_{5/2} (527.3 eV) and Sb³⁻ 3d_{3/2} (536.7 eV) peaks can be observed along with Na—O (529.0 eV), Na₂CO₃ (530.7 eV), and Na KLL (534.1 eV) peaks. As shown in FIG. 5C, there are two pairs of peaks in the high-resolution Te 3d spectrum. The strongest one can be assigned to Te²⁻ 3d_{5/2} at 570.8 eV and Te²⁻ 3d_{3/2} at 581.2 eV, followed by Te⁴⁺(TeO₂) 3d_{5/2} at 575.2 eV and Te⁴⁺(TeO₂) 3d_{3/2} at 585.6 eV. The existence of TeO₂ is ascribed to the slight oxidation on the sample surface, which often appears in the XPS spectra, such as Na₂Te. Both Sb³⁻ and Te²⁻ interact with Na+ to achieve charge neutrality in the compound. Since oxidation states of Sb³⁻ and Te²⁻ are different, for every two Sb³⁻ substitutional anions, there is one Te²⁻ vacancy generated. Therefore, the stoichiometry of NST was confirmed as Na₂(Sb_{2/6}Te_{3/6}Vac_{1/6}), agreeing with the DFT results.

As a baseline for structural analysis, Te powder was combined in an identical manner with Na, forming an equilibrium Na₂Te. Likewise, equilibrium Na₃Sb was formed when Sb powder was combined with Na. The structures of the composites were analyzed by XRD and DFT simulation. FIG. 8A shows XRD analysis of baseline as-synthesized metallurgical composites of Na₂Te—Na (NT-Na), Na₃Sb—Na (NS—Na), the fcc Na₂Te structure (Fm-3m, No. 225, a=b=c=0.7294 nm), the hcp Na₃Sb structure (P63/mmc, No. 194, a=b=0.5366 nm, c=0.9515 nm), and the bcc Na-metal matrix (lm-3m, No. 229, a=b=c=0.4291 nm).

The experimental XRD pattern for the as-received antimony telluride (Sb₂Te₃) power is shown in FIG. 8B, indicating that the material has the rhombohedral equilibrium structure (R3m, No. 166, a=b=0.4262 nm, c=3.0435 nm). According to FIG. 8B, Bragg peaks for Sb₂Te₃ are not present in NST-Na, indicating all Sb₂Te₃ has fully reacted with the Na metal.

The structural and compositional evolution during the rolling-folding process was also studied using XRD. As shown in FIG. 9, two characteristic peaks of Sb₂Te₃ at 28° and 38° gradually weaken from the second to the fifth rolling-folding iteration. After the tenth iteration, they fully disappear, demonstrating a complete reaction between Sb₂Te₃ and Na to form NST-Na. The additional 10 iterations were given to further homogenize the distribution of NST particles throughout the foil, with no further change in the XRD patterns being detected. FIG. 10A displays the XRD patterns of NST-Na with the Sb₂Te₃ to Na weight ratios of 1:4, 1:6, 1:8, and 1:10, corresponding to Sb₂Te₃ weight percentages of 20.0, 14.3, 11.1, and 9.1 wt %. From the patterns, it may be concluded that the structure of the metallurgical composites is identical, regardless of the initial Sb₂Te₃ loading.

FIG. 5D-5H investigate the structure and the electrochemical performance of NST-Na and of the baseline Na cells under deep-cycling conditions in 1 M NaPF₆ in G2 electrolyte. FIG. 5D shows a photograph of the as-fabricated NST-Na anode taken inside the glove box to prevent the Na metal from oxidizing. For this set of analyses, a Cu foil was employed to support the NST-Na electrode. This allowed for a direct comparison of the stripped Cu collector surfaces with NST-Na versus with the baseline Na, where a Cu foil was always employed. FIG. 5E shows a digital photograph of NST after Na was fully stripped from the electrode, highlighting the intact NST layer and the absence of any observable Na metal.

The disappearance of the Na peak in the XRD analysis, as shown in FIG. 11, further confirms the full stripping of Na metal. Comparable results were obtained for NST-Na electrodes with different initial Sb₂Te₃ weight loadings. As per the XRD analysis shown in FIG. 10B, there is no observable difference between the NSTs after Na was fully extracted. Without wishing to be bound by any theory, it was assumed that this effect is due to the structure of the thermodynamically stable NST not being affected by the Sb₂Te₃ to Na weight ratio. With relatively more Sb₂Te₃, however, a higher weight and volume fraction of the NST skeleton is achieved within the composite. It resulted in relatively more surface area being available to template the plating/stripping of the Na metal, reducing the effective current density. As will be demonstrated, higher NST loading leads to progressively improved electrochemical performance in terms of the plating/stripping overpotentials.

FIG. 5F shows a photograph of fully stripped NST followed by plating of 2 mAh cm⁻² capacity at a current of 1 mA cm⁻². The plated metal is macroscopically uniform, the metal surface remaining shiny. The plated morphology and structure of both electrodes will be investigated in more depth in the subsequent figures. FIG. 5G provides a photograph of the baseline Cu current collector also with a plated capacity of 2 mAh cm⁻² at 1 mA cm⁻². It may be observed how inhomogeneous the plating of Na metal on a standard Cu current collector is. The metal is concentrated on the sides of the collector, with macroscopic holes in the film through which the bare Cu is discernable. Apart from the main bulk of the Na film localized toward the upper left and lower bottom portions of the collector, there are also isolated spots of nucleated Na throughout the otherwise bare collector. It may be concluded that Na plating is macroscopically nonuniform from the onset, which explains the early voltage runaway failure observed during the baseline cycling. FIG. 5H shows a photograph of the Cu foil after attempting to strip all the Na metal from its surface. The severe discoloration of the Cu foil is likely associated with the remaining SEI layer, which is not removed by the electrode washing procedure. In addition, shiny Na metal is present on the electrode even after it was stripped to the terminal anodic voltage limit of 0.2 V. This is the “dead metal” or “dead sodium,” which was not strippable either due to being electrically isolated from the collector or due to being ionically blocked from dissolving. Both scenarios can be driven by excessive SEI growth. Electrical isolation occurs when the SEI is formed between the metal and the Cu collector, in effect acting as an insulating barrier layer between the two. Ionic insulation occurs if the SEI is thick enough and resistive enough to block the flow of Na^{□} from the shrinking metal despite there being sufficient electrical conductance. This combination of SEI and dead metal provides an explanation for the low CE observed with the baseline Na specimen when tested in a half-cell configuration.

FIG. 12 shows the top view and cross-sectional view SEM images and the associated EDXS maps of the post-stripped NST supported on the Cu substrate. The Na, Sb, and Te signals are correlated with the irregularly shaped NST particles, and there is no evidence for distinct regions containing only Na. FIG. 13 provides a FIB cross-sectional image of NST and the corresponding EDXS map. A percolated NST skeleton is observed, with the analytical maps showing a homogeneous Na, Sb, and Te distribution throughout. The observed pores in the structure were created after the metallic Na was stripped out. The EDXS analysis gives an atomic ratio of Na:Sb:Te is 6.06:1:1.58, approaching the stoichiometric ratio of 6:1:1.5 in Na₂(Sb_{2/6}Te_{3/6}Vac_{1/6}). FIG. 14 provides TEM images and the associated indexed selected area electron diffraction (SAED) ring pattern of NST. The indexed ring spacings are consistent with the XRD result shown in FIG. 11. It was found that SAED does not contain Na-metal diffraction rings. The 3D structure of NST is further elaborated through FIB-SEM tomography. The image shown is reconstructed from a total of 55 FIB cross-sectional slices, each with a thickness of 200 nm.

FIGS. 5I-5L display FIB cross-sectional SEM tomography of NST, highlighting its interconnected 3D structure, showing the front views and the back views, respectively. The NST skeleton consists of interconnected (percolated) intermetallic particles ranging in size from hundreds of nanometers to several micrometers, many particles likely being polycrystalline agglomerates. It is worth noting that the packing density and the associated porosity of the NST skeleton are related to the initial Sb₂Te₃ to Na-metal weight ratio. As indicated by the FIB cross-sectional SEM images in FIG. 15, the lower Sb₂Te₃ loadings lead to a looser and more porous NST scaffold. This may be an additional factor explaining the higher overpotentials observed with the lower loadings: During plating, progressively more Na would be plated onto pre-existing Na metal located within the larger pores rather than directly onto the less available NST surface. FIG. 16A shows XRD profiles of NST on different substrates (SS spacer, Cu foil) after Na was fully extracted at 1 mA cm⁻² in 1 M NaPF₆ in G2 electrolyte. FIG. 16B shows a FIB cross-sectional SEM image of NST on the SS spacer. It was found the structure and morphology of the NST are independent of the type of substrate employed.

FIGS. 5M-5P show the SEM images of early-stage Na deposition behavior on the Cu-supported NST and on the baseline bare Cu collector. The results are for cycle 1, with a plated capacity of 0.5 mAh cm⁻² at the current density of 1 mA cm⁻², in 1 M NaPF₆ in G2. Curved filament-like dendrites are present on the bare Cu foil even at the first plating cycle. The Na plated on NST is planar with a smooth surface. The plated capacity corresponds to 4.4 μm Na film in the ideal planar case, being thinner for the 3D NST support. In the SEM image, the NST is not fully covered by the Na metal and may be seen protruding onto the surface, especially in the top right region of the image. The plated Na is flat and uniform in its morphology, with no dendritic structures present. Analyses were also carried out using the carbonate electrolyte 1 M NaFSI in EC/DEC at cycle 1 and 0.5 mAh cm⁻². As shown in FIG. 17, uniform Na deposition is achieved with NST versus dendrites on the baseline Cu foil. Therefore, it can be concluded that the marked difference of the early-stage plating behavior with NST versus the baseline is a general feature spanning electrolyte classes.

FIGS. 18A-18I and FIGS. 19 and 20 display the electrochemical performance of symmetric NST-Na∥NST-Na and identically tested baseline cells of Na∥Na, NT-Na∥NT-Na, and NS-Na∥NS-Na. FIG. 18A shows these voltages versus time profiles, tested at 0.5 mA cm⁻² to a capacity of 0.25 mAh cm⁻² per cycle in 1 M NaFSI in EC/DEC electrolyte. FIG. 18B shows the profiles at 1 mA cm⁻² to 1 mAh cm⁻² per cycle in the same electrolyte. It was found that in a carbonate electrolyte, the baseline Na∥Na cells display early onset of unstable voltage, with significant fluctuations incurring by cycle 162 at 0.5 mA cm⁻² and by cycle 35 at 1 mA cm⁻². By contrast, the NST-Na∥NST-Na cells remain stable at these rates. They achieve 1500 cycles, 375 mAh cm⁻² cumulative capacity, and 1000 cycles, 500 mAh cm⁻² without voltage instability.

FIG. 19 shows additional cycling data collected at 0.5 mA cm⁻² to 2 mAh cm⁻², 1 mA cm⁻² to 0.25 mAh cm⁻², and 2 mA cm⁻² to 1 mAh cm⁻² in the same electrolyte. Here again, NST-Na displays markedly better performance than the baseline. Table 1 compares the plating capacity, DOD, and accumulated capacity of NST-Na∥NST-Na cells with state-of-the-art Na-metal anode literature.

It may be observed that from each of the three vantage points, the performance of NST-Na is among the most favorable. FIG. 20 shows the voltage profiles of NT-Na∥NT-Na and NS-Na∥NS-Na cells tested at 0.5 mA cm⁻² to 0.25 mAh cm⁻² per cycle, also in 1 M NaFSI in EC/DEC.

It may be concluded that although the NT-Na and NS—Na composites show improved electrochemical performance (more than doubled an quadrupled cycle life vs. baseline Na), they are inferior to NST-Na. This highlights the impact of the ternary NST-Na composite metallurgy in establishing uniform plating and stripping behavior of Na metal.

TABLE 1
Performance comparison of reported symmetrical cells in the literature and this work.

| | | | Plating | | Accumulated | |
|---|---|---|---|---|---|---|
| | Thick. | | capacity | DOD | Capacity | |
| Approach | μm | Electrolyte | (mAh cm⁻²) | (%) | (mAh cm⁻²) | Ref. |
| NST- | ~150 | 1M NaPF₆ in G2 | 10 | 60 | 1500 | This work |
| Intermetallics | | | | | | |
| NST- | ~150 | 1M NaPF₆ in G2 | 15 | 100 | 300 | This work |
| Intermetallics | | | | | | |
| Carbon felt host | 500 | 1M NaClO₄ in | 2 | 3.5 | 240 | [7] |
| | | EC/PC | | | | |
| rGO aerogel | N/A | 1M NaClO₄ in | 2 | N/A | 180 | [8] |
| | | EC/DEC | | | | |
| Sn—Na hybrid | ~450 | 1M NaPF₆ in | 0.25 | 0.5 | 250 | [9] |
| anode | | EC/PC | | | | |
| Na—Br interphase | N/A | 1M NaPF₆ in | 0.5 | N/A | 125 | [10] |
| | | EC/PC | | | | |
| rGO | ~200 | 1M NaOTf in | 5 | 22 | 750 | [11] |
| | | G2 | | | | |
| Na—Na₂S-carbon | 100 | 1M NaClO₄ in | 2 | 17.7 | 175 | [12] |
| | | EC/DEC/FEC | | | | |
| NaAsF₆ additive | N/A | 1M NATFSI in | 0.5 | N/A | 175 | [13] |
| | | FEC | | | | |
| SnCl₂ additive | N/A | 1M NaClO₄ in | 1 | N/A | 125 | [14] |
| | | EC/PC | | | | |
| Alloy layer | 1000 | 1M NaOTf in | 2 | 1.8 | 1200 | [15] |
| | | G2 | | | | |
| Channeled | >500 | 1M NaClO₄ in | 1 | 1.8 | 500 | [16] |
| carbon host | | EC/DEC | | | | |
| N, S, doped C- | ~200 | 1M NaOTf in | 1 | 4.4 | 250 | [17] |
| nanotube host | | G2 | | | | |
| ALD-AL₂O₃ | N/A | 1M NaClO₄ in | 1 | N/A | 30 | [18] |
| coated Na anode | | EC/DEC | | | | |
| SbF₃ SEI | 200 | 1M NaPF6 in | 10 | 44 | 800 | [19] |
| | | G2 | | | | |
| SnO₂ framework | ~120 | 1M NaOTf in | 1 | 7 | 500 | [20] |
| | | G2 | | | | |
| Na₃P SEI | ~400 | 1M NATFSI in | 1 | 2.2 | 390 | [21] |
| | | FEC/EMC | | | | |
| Na-rich | ~600 | 1M NaClO₄ in | 8 | ~12 | 960 | [22] |
| amalgams | | EC/PC | | | | |
| Na—MoS₂ | 35 | 1M NaClO₄ in | 0.25 | 6.3 | 25 | [23] |
| | | EC/DEC/FEC | | | | |
| SnS-graphene | 100 | 1M NaClO₄ in | 2 | 17.7 | 1000 | [24] |
| | | EC/DEC/FEC | | | | |
| Ti₃C₂Tₓ-rGO | 460 | 1M NaClO₄ in | 10 | 19.3 | 100 | [25] |
| | | EC/DMC/EMC/FEC | | | | |
| Oxygen-treated | N/A | 1M NaClO₄ in | 3 | N/A | 300 | [26] |
| Cu foam | | EC/DEC | | | | |
| Lignin-derived | 80 | 1M NaPF₆ in | 1 | 5.8 | ~180 | [27] |
| carbon nanofiber | | PC/FEC | | | | |
| Fe₂O₃ coated | N/A | 1M NaClO₄ in | 1 | 2.9 | ~167 | [28] |
| carbon textile | | EC/DMC | | | | |
| Carbon paper | N/A | 1M NaPF₆ in | 3 | 4.6 | 225 | [29] |
| with N-doped | | EC/PC | | | | |
| carbon | | | | | | |
| nanotubes | | | | | | |
| Na-carbon cloth | ~260 | 1M NaPF₆ in | 5 | ~64.2 | 400 | [30] |
| composite | | FEC/DMC | | | | |
| Nanocrevasse- | N/A | 1M NaOtf in | 1 | N/A | 100 | [31] |
| rich carbon fibers | | DME | | | | |
| SnO₂ quantum | N/A | 1M NaPF₆ in | 4 | N/A | 1400 | [32] |
| dots-carbon cloth | | G2 | | | | |
| Na/NaNO₃ | 400 | 1M NaClO₄ in | 3 | 3.5 | 200 | [33] |
| composite | | EC/DEC/FEC | | | | |
| N-functionalized | N/A | 1M NaOTf in | 2 | N/A | 800 | [34] |
| hard carbon | | G2 | | | | |
| Na@Au coated | 400 | 1M NaOTf in | 1 | 25 | 1000 | [35] |
| carbon foam | | G2 | | | | |
| Bi Nanoparticles | N/A | 1M NaOTf in | 4 | 66.7 | 425 | [36] |
| embedded | | G2 | | | | |
| carbon | | | | | | |
| nanosheets | | | | | | |
| Na@Doped | N/A | 1M NaOTf in | 1 | 25 | 500 | [37] |
| hollow carbon | | G2 | | | | |
| fibers | | | | | | |
| Sodium | N/A | 1M NaPF₆ in | 1 | N/A | 700 | [38] |
| benzenedithio- | | EC/PC | | | | |
| late protection | | | | | | |
| layer | | | | | | |

With NST-Na∥NST-Na cells, 1500 mAh cm⁻² cumulative capacity can be achieved in 1 M NaPF₆ in G2. The Na∥Na cells become unstable after 25 mAh cm⁻², as shown in FIG. 18C. FIG. 21 shows the voltage profiles of NST-Na∥NST-Na with different starting Sb₂Te₃ to Na-metal ratios, tested at 0.5 mA cm⁻² to 0.25 mAh cm⁻² per cycle in 1 M NaFSI in EC/DEC. The symmetric cells based on electrodes with a higher mass loading of NST exhibit a more stable cycling performance, although all the specimens are superior to the baseline. As mentioned earlier, relatively higher Sb₂Te₃ loading leads to relatively more NST that is available for plating of a given capacity of Na. This should reduce the effective current density and the associated overpotentials. The higher loading NST electrodes also display fewer large pores where the Na metal will accumulate and ultimately plate onto itself. This is another factor in reducing the plating and stripping overpotentials.

FIG. 18D shows the rate performance of the symmetric cells at a current density range of 0.5 to 5 mA cm⁻², tested in 1 M NaFSI in EC/DEC. The corresponding plating/stripping time is varied accordingly so as to achieve the targeted 1 mAh cm⁻² capacity per cycle. It may be observed that the NST-Na∥NST-Na exhibits markedly lower voltage polarization at each of the current densities, the difference versus the baseline increasing with the current. The baseline Na∥Na displays unstable voltage at 5 mA cm⁻² right at the onset and likewise becomes unstable at cycle 7 when the current is reduced to 0.5 mA cm⁻². By contrast, NST-Na∥NST-Na cycles through the entire current density regime in a stable manner. FIGS. 18E-18F provide expanded views of the fifth cycle galvanostatic curves for NST-Na∥NST-Na and Na∥Na symmetric cells, tested at 0.5 mA cm⁻² in 1 M NaFSI in EC/DEC. The baseline Na∥Na symmetric cell displays two distinct voltage plateaus. The first plateau at a lower voltage with ≈40% of capacity is followed by the second plateau at a higher voltage with ≈60% of capacity. The NST-Na∥NST-Na cell does not show this behavior, rather having a much smaller and nondescript single voltage plateau at either plating or stripping.

A Na∥Cu half-cell configuration also tested at 0.5 mA cm⁻² and 1 mAh cm⁻² at cycle 5 displays a CE of 40%. That result is shown in FIG. 22. The remaining 60% of capacity is possibly lost through the reaction of Na ions with the electrolyte to form additional SEI and the formation of dead metal. The two-plateau stripping and plating profiles of the symmetric Na∥Na cells may now be understood in the context of the half-cell results: The 40% capacity lower voltage plateau corresponds to stripping of the metal deposited in the prior cycle, while the 60% capacity higher voltage plateau corresponds to the necessity to strip the underlying fresh metal to achieve the targeted capacity per cycle. Since the cells are symmetrical, upon plating the working electrode, the same two-stage stripping profile is experienced on the counter electrode. A similar two-stage plateau was also observed in other common carbonate-based electrolytes. FIG. 23A displays the voltage versus capacity profiles of NST-Na∥NST-Na and Na∥Na symmetric cells at the fifth cycle in 1 M NaClO₄ in EC/DEC. With Na∥Na, two plateaus are present, the first plateau being at 45% of the total capacity. With NST-Na∥NST-Na tested identically, there is a single flat voltage plateau. FIG. 23B shows symmetric cells tested at 1 M NaClO₄ in EC/PC/FEC. The additive FEC is well-known to stabilize the SEI structure of metal anodes and improve their cycling performance. The improvement of Na∥Na cells with FEC additive can be understood by the elongated first plateau at a lower voltage, which accounts for 85% of the overall capacity, i.e., 85% CE. This is the highest CE for baseline Na∥Na cells among|electrolytes tested here. The NST-Na∥NST-Na cell continues to display a single plateau with relatively lower overpotentials.

FIG. 18G plots the average of the plating and stripping over-potentials at every cycle for 0.5 mA cm⁻² to 1 mAh cm⁻² per cycle in 1 M NaFSI in EC/DEC. The panel highlights the major differences in both the cycling stability and the average overpotentials with NST-Na∥NST-Na architecture. FIG. 18H displays the electrochemical impedance spectroscopy (EIS) results for the two sets of symmetrical cells after 5 cycles under the same conditions. The inset in the figure shows the model used for fitting the data. The NST-Na∥NST-Na cell has a lower combination of charge transfer resistance and SEI resistance than the Na∥Na cell, being at 54Ω versus 624Ω. This is indicative of a thinner, less resistive SEI layer formed with NST-Na∥NST-Na.

FIG. 18I shows a voltage profile of a purposely configured asymmetric NST-Na∥Na cell, tested analogously. In this case, the Na side experiences a two-stage stripping profile. However, the NST-Na side experiences a single-stage voltage profile. The asymmetry in the stripping behavior of the NST-Na versus the baseline Na electrodes is further confirmed. These electrochemical findings will be explained by the microstructural results reported later in the manuscript.

FIG. 24 explores the electrochemical performance of NST-Na cells under deep-cycling conditions in 1 M NaPF₆ in G2 electrolyte. For this analysis, deep cycling means at 100% DOD, i.e., fully stripped and then fully plated electrodes. This has not been examined in the literature for Na-metal anodes, particularly in terms of understanding the cycling versus microstructures in the 100% DOD states. As in Table 1, normally thick Na foils are employed for such tasks, with 5% or less of the metal undergoing plating and stripping at each cycle. Examining 100% DOD specimens, therefore, represents the most aggressive testing regimen in terms of anode volume changes and comes the closest to representing “anodeless”/“anode-free” configurations for full metal batteries where all the active ions are stored in the cathode. FIG. 24A shows the voltage versus time data for NST-Na∥NST-Na cells cycled under different DOD at 1 mA cm⁻². The active Na was first stripped from the NST-Na electrode (the first step shown in FIG. 24A), and then Na was repeatedly plated/stripped. The panel shows incremental increases in DOD going from left to right, starting with 20%, then 40%, 60%, 80%, and finally 100%, corresponding to a plated/stripped capacity of 15 mAh cm⁻². The amount of NST on each side of the cell stays fixed at 20 wt % of the initial mass loading. As per the XRD analysis in FIG. 25 in the Supporting Information, the NST phase is stable during anodic polarization that occurs when stripping, not changing its structure by any detectable measure. This indicates that at 100% DOD, a fixed NST skeleton interspersed with 15 mAh cm⁻² of Na metal is able to successfully template another 15 mAh cm⁻² of Na on top of it. The weight percentage of NST on the fully plated side is 11 wt %. On each electrode, the NST remains invariant whether the Na metal is stripping or plating.

Aggressive DOD experiments were also carried out in carbonate-based electrolytes. As shown in FIG. 26, 92% DOD is achieved in 1 M NaClO₄ in EC/PC/FEC, while 72% DOD is achieved in 1 M NaFSI in EC/DEC. By contrast, baseline Na can only cycle at 37% and 52% DOD before it short-circuits. Those results are shown in FIGS. 27A-27B. As shown in FIG. 27C, even in the ether-based electrolyte, baseline Na can only achieve 90% DOD.

FIGS. 24B-24E display voltage profiles, CE values, and average plating overpotentials for NST-Na electrode cycled under 100% DOD at 1 mA cm⁻². FIG. 28 shows similar tests but at more aggressive current densities of 3 and 5 mA cm⁻². It may be observed that at 100% DOD, the NST-Na cells remain stable with cycling, displaying an average CE of 99.4% at 1 mA cm⁻² after 1000 h. It also exhibits stable cycling profiles over 500 h at 100% DOD, tested at 3 and 5 mA cm⁻² with average CEs of 99.3% and 99.1%. Such voltage stability and relatively high CE have not been reported for Na-metal anodes undergoing complete plating and stripping at every cycle.

Sputter-down XPS was employed to further understand the SEI structure in NST-Na and the baseline Na. These results are shown in FIGS. 29A-29H. The specimens were analyzed after five cycles at 0.5 mA cm⁻² with a capacity of 1 mAh cm⁻² in 1 M NaFSI in EC/DEC. The integral areas of the individual peaks were obtained, allowing for an estimate of the normalized content of each component. This is presented in the form of bar charts in FIG. 29D for NST-Na and FIG. 29H for Na. For both electrodes, the SEI mainly consists of Na₂CO₃, Na₂O, and NaF. The ratio of the NaF component is slightly higher in the SEI for NST-Na. Overall the SEI composition-phase content is analogous for both electrodes, indicating the NST does not substantially affect the SEI chemistry per se. The key differences are then in the initial SEI thickness and its cycling-induced growth. This is quantitatively supported by the EIS results and qualitatively by the light optical observations of the initial stripped Cu surface. It will also be quantitatively substantiated by the cryo-FIB and cryo-TEM analysis shown in the next set of figures.

FIG. 30 presents SEM, cryo-FIB cross-sectional SEM, and cryo-TEM analysis comparing NST-Na versus Na in the plated condition. Samples underwent 5 cycles at 0.5 mA cm with a plated capacity of 1 mAh cm⁻² per cycle in 1 M NaFSI in EC/DEC. FIGS. 30A-30D highlights analysis of NST-Na, while FIGS. 30E-30H show comparable analysis for Na. FIGS. 30A and 30E show top-view SEM images. FIGS. 30B-30D and 30F-30H show SEM images and EDXS maps of cryo-FIB lift-out NST-Na and baseline Na specimens. FIGS. 301-30J provide cryo-TEM images of the cross-sections of NST-Na in plated condition. FIGS. 30K-30L display this analysis for Na, with arrows highlighting the porosity in the metal.

There is a striking difference in the structure and the morphology of the plated metal for the two specimens. For the case of NST-Na, the plated metal is dense, being free from pores and from embedded SEL. The surface morphology of NST is flat, with no evidence of dendrites. The metal is free from nano porosity, as shown in the higher-resolution TEM images. By contrast, the baseline Na electrode is effectively a three-phase sponge: Through the entire structure, the plated metal is interspersed with the SEL. Micrometer-scale pores are present everywhere throughout the plated structure, visible in the cross-sectional SEM and in the cross-sectional TEM (arrowed) images. This triphasic structure is developed early in cycling and is fundamentally different from the classical view of dendrites as isolated protrusions emanating from a uniform metal foil. The extensive SEI formation throughout the electrode can explain the 40% CE observed in cycle 1.

FIGS. 31-33 show SEM images comparing the deposition morphology for NST-Na versus bare Na in various plated conditions. These samples were analyzed after 1 cycle at 1 mA cm⁻², with plating capacities of 5, 10, and 26 mAh cm⁻², in 1 M NaFSI in EC/DEC. The observed structures are consistent at the three conditions: dense, relatively smooth metal for NST-Na versus a porous dendritic structure for baseline Na.

Full battery cell testing was performed to further evaluate the feasibility of NST-Na electrodes. The cells were based on Na₃V₂(PO₄)₃ (NVP) or sulfur (S)-based cathodes combined with NST-Na or Na. As shown herein, three-electrode electroanalytic work was performed to further understand the performance. FIG. 34A shows the voltage profiles of NST-Na∥NVP and Na∥NVP cells at 1 C (1 C equals to 118 mA g⁻¹ based on the mass of NVP) in 1 M NaFSI in EC/DEC electrolyte. FIG. 34B displays three-electrode analyses showing the voltage of the NVP cathode and the Na anode. FIG. 34C compares the cycling stability of NST-Na∥NVP and Na∥NVP. Na∥NVP two-electrode cell shows two discharge plateaus in carbonate electrolyte. The first of which gives a capacity of about 40 mAh g⁻¹ and is present at ≈3.34 V, followed by the second plateau with 60 mAh g⁻¹ at ≈3.24 V. The voltage of the NVP cathode and Na anode was measured using a three-electrode cell. During discharge, the voltage of the NVP cathode (working electrode) displays a single plateau, while the Na anode (counter electrode) exhibits two plateaus. This is in accordance with the voltage profile of the Na∥Na symmetrical cells discussed previously. The second discharge plateau in the full battery is due to the Na anode polarization, in turn, as a result of its poor CE and the need to strip fresh Na metal to compensate for the loss of active ions. While two-stage plateaus have been reported previously for NVP versus Na metal, this is the first explicit explanation for this behavior. When NVP is coupled with NST-Na, the two-electrode cell shows a single discharge plateau at ≈3.34 V. This is due to the low overpotential and high CE stripping behavior of NST-Na, which utilizes almost all the previously plated Na. The single high-voltage discharge voltage enables an increase of 8.5% in the specific energy of the cell.

FIG. 35A displays the rate performance of NST-Na∥NVP and Na∥NVP full cells. Stepwise increasing the current densities from 0.2 C, 0.5 C, 1 C, 2 C, 5 C, 10 C, 15 C to 20 C, the NST-Na∥NVP cell delivers reversible capacities of 109, 105, 105, 103, 101, 97, 93, 90, and 87 mAh g⁻¹, respectively. When the current is switched from 20 C back to 0.2 C, the reversible capacity is restored to the original level. At every current density, the baseline Na∥NVP exhibits a lower capacity. The NST-Na∥NVP cell can be stably cycled for over 1000 cycles at 1 C with 91% capacity retention and an average CE of 99.9%. FIG. 36A provides the specific energy of the cells. NST-Na∥NVP delivers a specific energy of 296 Wh kg⁻¹ after 1000 cycles at a specific power of 380 W kg⁻¹. In contrast, Na∥NVP can be cycled less than 600 times with a fluctuating CE, as shown in FIG. 36B. As shown in FIG. 34C, when cycled at an extremely fast rate of 10 C, the CE of NST-Na∥NVP remains quite high after 1000 cycles. Table 2 compares the rate capability and cycling behavior of NST-Na∥NVP versus literature-reported NVP-based cells with modified Na anodes. It may be concluded that the electrochemical performance of NST-Na∥NVP is among the most favorable.

Sodium-sulfur batteries are exciting because of their high theoretical energy and low cost. FIG. 34D provides selected voltage profiles of NST-Na∥S and Na∥S at 0.5 C (1 C equals to 1675 mA g⁻¹ based on the mass of S) in 1 M NaFSI in EC/DEC. FIG. 34E gives the cycling stability and CE of NST-Na∥s and Na∥S cells. FIG. 37 displays selected voltage profiles of NST-Na∥S and Na∥S cells in 1 M NaClO₄ in EC/PC/FEC. FIG. 34F shows the cycling stability and CE of NST-Na∥S and Na∥S cells at 0.5 C in 1 M NaClO₄ in EC/PC/FEC. For Na—S, the crossover of polysulfides results in a relatively low cycle life. Overall, however, the cycling performance is noticeably improved when employing NST-Na. The cycling life increases from 150 with baseline Na to greater than 1000 cycles with NST-Na, its CE remaining at over 99%. When FEC-containing electrolyte was employed, the capacity of Na—S cells was boosted as well. However, cells with bare Na electrodes still suffered from severe capacity decay after 200 cycles. Those with NST-Na exhibited markedly more stable cycling performance. The baseline Na—S cells display two discharge plateaus in both electrolytes after cycle 1, but they are not quite identical: The second plateau in the FEC-containing electrolyte (0.7 V) appears at a lower voltage than that in non-FEC-containing electrolyte (1.05 V), corresponding to a longer first stripping plateau of Na anode. By contrast, the NST-Na∥S cell exhibits a single plateau in both electrolytes. The different discharge processes between NST-Na∥S and Na∥S cells result from the distinct anode stripping behaviors as per the previous discussion. The lower polarizations in NST-Na∥S cells also contribute to their greater performance.

FIG. 35B shows the rate performance of NST-Na∥S and Na∥S cells. Results demonstrate that the NST-Na∥S cell out-performs the Na∥S cell, the difference increasing with current density. For example, at 5 C, the NST-Na∥S cell delivers a reversible capacity of 495 mAh g⁻¹, while the baseline Na∥S cell only achieves 191 mAh g⁻¹ “Anode-free”/“anodeless” metal batteries are attractive due to reduced manufacturing cost, reduced need for Li/Na/K metal, increased specific energy and volumetric energy, as well as improved safety. Since, in the ideal case, there is no ion reservoir apart from what is in the cathode, CEs approaching 100% are crucial. FIG. 34G shows voltage profiles of Na∥NVP and Cu∥NVP in an anodeless configuration. FIGS. 34H-34I provide voltage profiles and cycling performance of an anode-free cell with an NVP cathode (source of Na) and NST versus baseline Cu collector. A fully-stripped NST-Na anode was employed as the NST current collector, the desodiation being performed prior to cell assembly. The first charge capacity of a Cu∥NVP cell is almost the same as that of a Na—NVP cell (95 mAh g⁻¹ vs. 97 mAh g⁻¹). However, only 27 mAh g⁻¹ is recovered for Cu—NVP, indicating a CE of 30%. The anode-free cell using NST gives a cycle 1 CE of 92.3% and a steady-state cycling CE of upward of 99.7%. SEM and EIS analyses were performed to further elucidate the differences between Cu∥NVP and NST∥NVP after the first charge (plating) and after the first discharge (stripping).

TABLE 2
Performance comparison of reported NVP cells with
modified Na anodes in theliterature and this work.

| | | Rate Capability | | | | | |
|---|---|---|---|---|---|---|---|
| | | (mAh g⁻¹) | | Cycling Performance | | | |
| | | Current, | Capacity | Current, | Capacity | Cycle | |
| Anode Material | Electrolyte | (C) | (mAh g⁻¹) | (C) | (mAh g⁻¹) | Number | Ref. |
| NST-Intermetallics | 1M NaFSI in | 20 | 87 | 1 | 90 | 1000 | This |
| | EC/DEC | | | 10 | 87 | 1000 | work |
| N-doped graphene on | 1M NaPF₆ in G2 | 20 | 75 | 2 | 93 | 250 | [39] |
| Ni foam@ deposited | | | | | | | |
| Na | | | | | | | |
| (Ti₃C₂Tₓ)-coated | 1M NaClO₄ in | ~8.5 C | ~80 | ~4.2 | ~88 | 300 | [40] |
| carbon cloth@infused | EC/DMC/EMC/FEC | | | | | | |
| Na | | | | | | | |
| Activated SnS- | 1M NaClO₄ in | N/A | N/A | 0.4 | 74 | 400 | [24] |
| graphene | EC/DEC/FEC | | | | | | |
| membrane@Na | | | | | | | |
| 3D Ni foam@Na | 1M NaPF₆ in | 2 | 76 | 1 | 75 | 200 | [41] |
| | TEGDME | | | | | | |
| Cu₂O—NWs modified | 1M NaClO₄ in | N/A | N/A | 1 | 89 | 400 | [42] |
| Cu foam @infused Na | EC/DMC/FEC | | | | | | |
| Porous carbon | 1M NaOTf in G2 | N/A | N/A | 1 | 75 | 900 | [43] |
| nanofibers@deposited | | | | | | | |
| Na | | | | | | | |
| 3D porous | 1M NaPF₆ in G2 | N/A | N/A | 1 | 92 | 100 | [44] |
| Cu@deposited Na | | | | | | | |
| Na—Na₂S-carbon | 1M NaClO₄ in | 20 | 33 | 1 | 54 | 500 | [12] |
| hybrid | EC/DEC/FEC | | | | | | |
| 3D printed | 1M NaPF₆ in G2 | N/A | N/A | ~0.85 | 68 | 100 | [45] |
| rGO/CNT@deposited | | | | | | | |
| Na | | | | | | | |
| Porous | 1M NaPF₆ in G2 | N/A | N/A | ~3 | 95 | 350 | [46] |
| rGo@deposited Na | | | | | | | |
| SnCl₂ additive | 1M NaClO₄ in EC/PC | 10 | 101 | 1 | ~100 | 250 | [14] |
| N-doped hollow | 1M NaClO₄ in EC/PC | 5 | 102 | N/A | 94 | 200 | [37] |
| carbon | | | | | | | |
| fibers@deposited Na | | | | | | | |
| Na | 1M NaPF₆ in | 5 | 85 | N/A | N/A | N/A | [47] |
| | G2/Ionic liquid | | | | | | |
| Na | 1M NaTFSI in | 5 | 85 | 1 | 93 | 400 | [48] |
| | TMP/FEC/HFE | | | | | | |
| Co-graphene/carbon | 1M NaClO₄ in | ~8.5 | 59 | ~1.7 | ~65 | 370 | [49] |
| cloth@infused Na | EC/DMC/EMC | | | | | | |

As shown in FIG. 38, the SEM images show that dead metal with dendritic features remains on the stripped Cu surface. By contrast, there is no discernible Na left on the NST surface. FIG. 39 provides the EIS analysis on the CU∥NVP and NST∥NVP cells at different charge-discharge states. There is a notable difference at the first discharge state. The combination of charge transfer resistance and SEI resistance of a Cu∥NVP is larger than that of an NST∥NVP; being 609 and 317Ω, respectively. These results agree well with the analytical and electroanalytical findings for the symmetric and the half-cells.

The enhanced early-stage wettability of Na on the NST surface was examined by DFT calculations. If Na clusters are more thermodynamically stable than Na atoms, early-stage wetting behavior will favor 3D islands rather than atomically thin continuous films. This would naturally lead to dendrites as the film thickness increases. If Na atoms are more stable as compared to Na clusters, the initially plated film will cover the surface uniformly. This scenario does not exclude the possibility of Stransk-Krastanov type dewetting away from the interface during later stages of deposition. However, there is little evidence for such behavior with NST support. The binding energies of Na atoms and Na clusters on the (100) fcc NST surface were calculated and compared to (111) fcc Cu, (110) bcc Na, and (110) fcc Na₂Te. The Na₂Te was treated as a baseline reference model for NST because of the similarity in their structure. From surface energy calculations (Table 3), the Cu (111) surface has the lowest surface energy as compared to Cu (110) and Cu (200). The binding energies were calculated in two configurations: a) Na clusters and b) individual Na atoms. Since it is not known at what Na coverage dendrites first form, cases considered ranged from single atoms to Na clusters with 4-5 atoms. Clusters that were larger in size were too demanding computationally to calculate in practical time frames. On NST and baseline NT surfaces, there is a preference for Na atoms to disperse on the surface. For clusters of 4-5 atoms, there is a clear energetic difference for wetting as compared to clustering. The structures of Na₄/Na₅ clusters and four/five individual Na atoms on the respective surfaces are shown in FIGS. 40 and 41. As discussed, a relatively stronger binding energy of individual Na atoms as compared to clusters indicates the propensity to deposit uniformly on a given surface.

The surface energies were calculated using the equation below using the DFT computed energy of the surface (E_{slab}), the energy of the bulk per atom in fcc Cu, the number of atoms in the surface (N), and surface area A.

$$γ = \frac{{E}_{slab} - N * {E}_{bulk}}{2 A}$$

TABLE 3
Surface Energies for fcc Cu and fcc Na₂Te.

| Surface (hkl) | Surface Energy per atom, γ (J/m²) |
|---|---|
| fcc Cu (111) | 0.010 |
| fcc Cu (110) | 0.016 |
| fcc Cu (200) | 0.008 |

The binding energy of the Na₄ cluster, Na₅ cluster, four, and five sodium atoms are shown in Table 4. Outcomes with the most positive binding energy are the least thermodynamically stable. On the Cu (111) surface, the four/five individual Na atoms and Na₄/Na₅ clusters are almost equally stable, indicating there is a minimal energetic preference for early-stage islands versus early-stage planar films. This is perhaps the most meaningful outcome of the simulation. It indicates that the experimentally observed early-stage plated film morphology is kinetically determined, being influenced by factors such as the heterogeneity of the Na-ion flux through the liquid (electrolyte wetting) and through the solid (SEI).

TABLE 4
Binding energies for multiple sodium atoms and
sodium clusters on the relevant surfaces

| Binding energy | Four Na | Na₄ | Five Na | Nas |
|---|---|---|---|---|
| per Na [eV] | atoms | cluster | atoms | cluster |
| (111) fcc Cu | −1.21 | −1.21 | −0.67 | −0.69 |
| (100) fcc NST | 0.01 | 0.12 | 0.05 | 0.11 |
| (110) fcc Na | 0.19 | 0.10 | 0.16 | 0.06 |
| (110) fcc Na₂Te | 0.17 | 0.23 | 0.19 | 0.27 |

With NST, four and five Na atoms are significantly more stable than the clusters, indicating that there is a thermodynamic driving force for complete coverage of the support during early-stage plating. Interestingly, on pre-existing Na metal, the individual atoms are less stable than the clusters. This implies a thermodynamic propensity for roughening of the Na-metal surface during ongoing film growth. This is observed even with NST, where the film morphology is not perfectly planar, especially at a higher capacity. It would be difficult to separate these thermodynamic roughening effects from kinetic factors that also influence the film surface morphology. The baseline Na₂Te surface results yield more stable Na atoms as compared to clusters, though the energetic difference is not as significant as with NST. As discussed previously, Na₂Te is known to decompose during anodic polarization through a conversion reaction, making it structurally unstable support. Therefore, the uniqueness of NST lies both in the relatively high thermodynamic stability that groups of Na atoms display on its surface and in its own thermodynamic stability that resists decomposition during extended cycling.

FIG. 42 summarizes the electrochemical stabilization effect of NST, comparing it to the baseline Na. The schematic treats a scenario with 100% DOD, analogous to the configuration shown in FIGS. 5D-5H. At plating cycle 1, the wetting behavior of the Na metal on the Cu substrate is poor. Rather than forming a conformal film, a macroscopically heterogeneous island structure is formed. Such metal coverage leads to a geometrically nonuniform SEI on the electrolyte-exposed surfaces. There is also the formation of “dead metal” upon cycle one stripping, with additional dead metal forming at subsequent cycles. During cycling, the SEI is never fully stable, as indicated by the poor CE of the half-cells and of the 100% DOD cells, as well as by the impedance values obtained from EIS. From the onset of cycling, the plating overpotentials of the baseline Na are higher than for NST-Na, with their difference increasing with cycle number. Relatively higher overpotentials have been theoretically linked to a transition from planar metal growth to island metal growth. A thickening SEI will therefore promote even worse wetting in the subsequent cycle. A deleterious synergy results, where poor metal wetting, increasing overpotentials, and SEI growth become self-amplifying. This leads to a triphasic microstructure observed, consisting of curved Na-metal filaments that are interspersed with SEI and with pores.

### CONCLUSION

Sodium-metal batteries (SMBs, NMBs) are hindered by nonuniform plating/stripping of the anode with unstable SEI and potentially catastrophic dendrite growth. Here, a repeated cold rolling and folding method were employed to fabricate a metallurgical composite of thermodynamically stable (as per DFT simulations) sodium antimony telluride Na₂(Sb_{2/6}Te_{3/6}Vac_{1/6}) intermetallic crystallites that are densely dispersed in Na metal, termed “NST-Na.” The disclosed herein intermetallic template allowed for state-of-the-art electrochemical performance in both carbonate and ether electrolytes. For example, NST-Na achieved 100% DOD (15 mAh cm⁻²) at 1 mA cm⁻² with CE of 99.4% for 1000 h plating/stripping time. Coupled with NVP or sulfur-based cathodes, improved energy, Coulombic efficiency, and cycling are demonstrated. The cell lifetime of the NST-Na∥sulfur battery has increased from 150 to over 1000 cycles. An anode-free cell consisting of an NST anode collector and an NVP cathode was cycled with a capacity loss of only 0.23% per cycle. At cycle 1, NST-Na plates uniformly and strips completely. Baseline Na plates nonuniformly include the formation of filament-like dendrites clustered in macroscopic islands. The stripped Cu surface contains macroscopic islands of shiny dead metal that is not electrochemically active enough to be removed. Cryo-TEM analysis on cryo-FIB cross-sections combined with XPS demonstrates that cycled NST-Na is dense and pore-free, flat on its surface with a stable SEI. The cycled baseline bulk microstructure is triphasic; all the metal is a form of curved dendritic filaments that are interspersed with SEI and with pores. A mechanistic explanation of these combined results is put forth, being directly supported by DFT analysis. One key scientific takeaway is that templated growth is necessary for the electrochemical stability of Na metal and that dendritic growth is the default on a standard foil.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Example 1: An ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and wherein the ionophilic template is a support material for a metal anode.

Example 2: The ionophilic template of any examples herein, particularly example 1, wherein a ratio of Sb to the M is from greater than 0 to 100 wt % and wherein a ratio of Te to the M is from greater than 0 to 100 wt %.

Example 3: The ionophilic template of any examples herein, particularly example 1 or 2, wherein the ionophilic template is configured to provide a depth-of-discharge of the metal anode from about 1% to 100%.

Example 4: The ionophilic template of any examples herein, particularly example 3, wherein the ionophilic template is configured to provide a coulombic efficiency of the metal anode greater than about 50% at a current density from about 0.1 mA cm⁻² to about 10 mA cm⁻².

Example 5: The ionophilic template of any examples herein, particularly example 3 or 4, wherein the ionophilic template is configured to exhibit substantially stable cycling profiles for greater than about 1 hour.

Example 6: The ionophilic template of any examples herein, particularly example 5, wherein the ionophilic template is configured to exhibit substantially stable cycling profiles up to about ten years.

Example 7: The ionophilic template of any examples herein, particularly examples 1-6, wherein the ionophilic template is prepared by metallurgical processing, thin films deposition, wet and dry processing, chemical and electrochemical dealloying, spin coating, spray drying, thermal and/or hydrothermal processing.

Example 8: An electrochemical cell comprising: a) a support material for a metal anode comprising an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and b) an electrolyte.

Example 9: The electrochemical cell of any examples herein, particularly example 8, wherein a ratio of Sb to the M is from greater than 0 to about 100 wt % and wherein a ratio of Te to the M is from greater than 0 to about 100 wt %.

Example 10: The electrochemical cell of any examples herein, particularly examples 8-9, wherein the electrolyte comprises a salt and a non-aqueous solvent.

Example 11: The electrochemical cell of any examples herein, particularly example 10, wherein the salt comprises a potassium, sodium, lithium, magnesium, calcium, or aluminum salt of bis(fluorosulfonyl) imide, perchlorate, tetrafluoroborate hexafluorophosphate, hexafluroarsenate, or a potassium, sodium, or lithium salt of aluminum tetrachloride, boron tetrachloride iodide, chlorate, borate, iodate, or a combination thereof.

Example 12: The electrochemical cell of any examples herein, particularly example 10 or 11, wherein the non-aqueous solvent comprises dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

Example 13: The electrochemical cell of any examples herein, particularly example 12, wherein glymes comprise diglyme, tetraglyme, or a combination thereof.

Example 14: The electrochemical cell of any examples herein, particularly example 8 or 9, wherein the electrolyte is a solid electrolyte comprising sulfide compounds, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Example 15: The electrochemical cell of any examples herein, particularly examples 8-9, wherein the electrolyte is a hybrid liquid-solid electrolyte.

Example 16: The electrochemical cell of any examples herein, particularly examples 8-15, wherein the support material is disposed on a substrate.

Example 17: The electrochemical cell of any examples herein, particularly example 16, wherein the substrate comprises stainless steel, aluminum, tungsten, titanium, copper, polymer, or a combination thereof.

Example 18: The electrochemical cell of any examples herein, particularly examples 8-17, wherein the electrochemical cell is a battery.

Example 19: The electrochemical cell of any examples herein, particularly example 18, wherein the battery is a secondary battery.

Example 20: The electrochemical cell of any examples herein, particularly examples 8-19, wherein the electrochemical cell further comprises a cathode material.

Example 21: The electrochemical cell of any examples herein, particularly example 20, wherein the cathode is a metal cathode or a composite cathode.

Example 22: The electrochemical cell of any examples herein, particularly example 21, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

Example 23: The electrochemical cell of any examples herein, particularly examples 8-22, wherein the cell exhibits a substantially stable plating and stripping cycling for at least about 1 hour at a current density from about 0.1 mA cm⁻² to about 10 mA cm⁻².

Example 24: The electrochemical cell of any examples herein, particularly example 23, wherein the cell exhibits substantially stable plating and stripping cycling for up to about ten years.

Example 25: The electrochemical cell of any examples herein, particularly example 23 or 24, wherein the cell exhibits a coulombic efficiency of greater than about 50%.

Example 26: The electrochemical cell of any examples herein, particularly examples 8-25, wherein the cell exhibits a reversible capacity up to about 1,000 mAh/g.

Example 27: The electrochemical cell of any examples herein, particularly examples 8-26, wherein the cell exhibits a specific energy from about 1 to about 1,000 Wh/kg after about 100,000 cycles at a specific power of 1 to about 10,000 W/kg.

Example 28: The electrochemical cell of any examples herein, particularly examples 8-27, wherein substantially no dendrites are formed during a plating cycle.

Example 29: An electrochemical cell comprising: a) a support material for a metal anode comprising an ionophilic template comprising a microscopic array having a formula of Mₐ(SbₓTe_{y}Vac_{z}), wherein an M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1, wherein the microscopic array is dispersed within a metal comprising the M, and b) a solid electrolyte comprising sulfide compounds, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Example 30: A method of making an ionophilic template: disposing an amount of Sb₂Te₃ within a metal M to form a microscopic array having a formula of Mₐ(SbₓTe_{y}Vac_{z}), wherein the M comprises one or more of Na, Li, K, Mg, Ca, Al, Zn, or alloys thereof; a Vac refers to vacancies present in a lattice of the microscopic array; wherein 0≤a≤100, 0≤x≤1; 0≤y≤1; and 0≤z≤1.

Example 31: The method of any examples herein, particularly example 30, wherein the Sb₂Te₃ is provided in a ratio to the metal M from greater than 0 wt % to about 100 wt %.

Example 32: The method of any examples herein, particularly examples 30-31, wherein the step of disposing comprises incorporating Sb₂Te₃ within the metal M by a rolling-folding process.

Example 33: The method of any examples herein, particularly examples 30-31, wherein the step of disposing comprises depositing a thin film of Sb₂Te₃ on the metal M and thermally incorporating Sb₂Te₃ within the metal M.

Example 34: The method of any examples herein, particularly examples 30-31, wherein the step of disposing comprises chemical and electrochemical dealloying, spin coating, spray drying, thermal and/or hydrothermal, or any combination thereof.

Example 35: The method of any examples herein, particularly examples 30-34, wherein a ratio of Sb to the M is from greater than 0 to 100 wt % and wherein a ratio of Te to the M is from greater than 0 to 100 wt %.

Example 36: The method of any examples herein, particularly examples 30-35, wherein the ionophilic template is configured to provide a depth-of-discharge of the metal anode from about 1% to 100%.

Example 37: The method of any examples herein, particularly example 36, wherein the ionophilic template is configured to provide a coulombic efficiency of the metal anode greater than about 50% at a current density from about 0.1 mA cm⁻² to about 10 mA cm⁻².

Example 38: The method of any examples herein, particularly examples 36 or 37, wherein the ionophilic template is configured to exhibit substantially stable cycling profiles for greater than about 1 hour.

Example 39: The method of any examples herein, particularly example 38, wherein the ionophilic template is configured to exhibit substantially stable cycling profiles up to about 10 years.

Example 40: A method of forming an electrochemical cell: providing the ionophilic template of any examples herein, particularly examples 1-7; and providing an electrolyte.

Example 41: The method of any examples herein, particularly example 40, wherein the electrochemical cell is a battery.

Example 42: The method of any examples herein, particularly example 41, wherein the battery is a secondary battery.

Example 43: The method of any examples herein, particularly examples 40-42, wherein the ionophilic template is a support material.

Example 44: The method of any examples herein, particularly example 43, wherein the support material is disposed on a substrate.

### REFERENCES

[1] W. Ren, Z. Zheng, C. Xu, C. Niu, Q. Wei, Q. An, K. Zhao, M. Yan, M. Qin, L. Mai, Nano Energy 2016, 25, 145.
[2] H. Guo, B. Ruan, L. Liu, L. Zhang, Z. Tao, S. Chou, J. Wang, H. Liu, Small 2017, 13, 1700920.
[3] G. Kresse, J. Furthmuller, Phys. Rev. B 1996, 54, 11169; b) J. P. Perdew, K. Burke, M. Ernzerhof, Phys. Rev. Lett. 1996, 77, 3865; c) E. Bitzek, P. Koskinen, F. Gshler, M. Moseler, P. Gumbsch, Phys. Rev. Lett. 2006, 97, 170201.
[4] P. E. Blochl, Phys. Rev. B 1994, 50, 17953.
[5] H. J. Monkhorst, J. D. Pack, Phys. Rev. B 1976, 13, 5188.
[6] K. Momma, F. Izumi, J. Appl. Crystallogr. 2008, 41, 653.
[7] S.-S. Chi, X.-G. Qi, Y.-S. Hu, L.-Z. Fan, Adv. Energy Mater. 2018, 8, 1702764.
[8] F. Wu, J. Zhou, R. Luo, Y. Huang, Y. Mei, M. Xie, R. Chen, Energy Storage Mater. 2019, 22, 376.
[9] Z. Tu, S. Choudhury, M. J. Zachman, S. Wei, K. Zhang, L. F. Kourkoutis, L. A. Archer, Nat. Energy 2018, 3, 310.
[10] S. Choudhury, S. Wei, Y. Ozhabes, D. Gunceler, M. J. Zachman, Z. Tu, J. H. Shin, P. Nath, A. Agrawal, L. F. Kourkoutis, T. A. Arias, L. A. Archer, Nat. Commun. 2017, 8, 898.
[11] A. Wang, X. Hu, H. Tang, C. Zhang, S. Liu, Y. W. Yang, Q. H. Yang, J. Luo, Angew. Chem. Int. Ed. 2017, 56, 11921.
[12] W. Wu, S. Hou, C. Zhang, L. Zhang, ACS Appl. Mater. Interfaces 2020, 12, 27300.
[13] S. Wang, W. Cai, Z. Sun, F. Huang, Y. Jie, Y. Liu, Y. Chen, B. Peng, R. Cao, G. Zhang, S. Jiao, Chem. Commun. 2019, 55, 14375.
[14] X. Zheng, H. Fu, C. Hu, H. Xu, Y. Huang, J. Wen, H. Sun, W. Luo, Y. Huang, J. Phys. Chem. Lett. 2019, 10, 707.
[15] S. Tang, Y. Y. Zhang, X. G. Zhang, J. T. Li, X. Y. Wang, J. W. Yan, D. Y. Wu, M. S. Zheng, Q. F. Dong, B. W. Mao, Adv. Mater. 2019, 31, 1807495.
[16] W. Luo, Y. Zhang, S. Xu, J. Dai, E. Hitz, Y. Li, C. Yang, C. Chen, B. Liu, L. Hu, Nano Lett. 2017, 17, 3792.
[17] B. Sun, P. Xiong, U. Maitra, D. Langsdorf, K. Yan, C. Wang, J. Janek, D. Schröder, G. Wang, Adv. Mater. 2020, 32, 1903891.
[18] W. Luo, C. F. Lin, O. Zhao, M. Noked, Y. Zhang, G. W. Rubloff, L. Hu, Adv. Energy Mater. 2017, 7, 1601526.
[19] Z. Xu, J. Yang, T. Zhang, L. Sun, Y. Nuli, J. Wang, S. Hirano, Adv. Funct. Mater. 2019, 29, 1901924.
[20] X. Zheng, W. Yang, Z. Wang, L. Huang, S. Geng, J. Wen, W. Luo, Y. Huang, Nano Energy 2020, 69, 104387.
[21] P. Shi, S. Zhang, G. Lu, L. Wang, Y. Jiang, F. Liu, Y. Yao, H. Yang, M. Ma, S. Ye, X. Tao, Y. Feng, X. Wu, X. Rui, Y. Yu, Adv. Energy Mater. 2020, 11, 2003381.
[22] Q. Zhang, M. Hu, J. He, X. Liu, G. He, Y. Ding, J. Mater. Chem. A 2020, 8, 6822.
[23] C. Yang, K. Fu, Y. Zhang, E. Hitz, L. Hu, Adv. Mater. 2017, 29, 1701169.
[24] W. Liu, Z. Chen, Z. Zhang, P. Jiang, Y. Chen, E. Paek, Y. Wang, D. Mitlin, Energy Environ. Sci. 2021, 14, 382.
[25] Y. Fang, Y. Zhang, K. Zhu, R. Lian, Y. Gao, J. Yin, K. Ye, K. Cheng, J. Yan, G. Wang, Y. Wei, D. Cao, ACS Nano 2019, 13, 14319.
[26] C. Wang, H. Wang, E. Matios, X. Hu, W. Li, Adv. Funct. Mater. 2018, 28, 1802282.
[27] L. Tao, A. Hu, L. Mu, D. J. Kautz, Z. Xu, Y. Feng, H. Huang, F. Lin, Adv. Funct. Mater. 2020, 31, 2007556.
[28] W. S. Xiong, Y. Jiang, Y. Xia, Y. Qi, W. Sun, D. He, Y. Liu, X. Z. Zhao, Chem. Commun. 2018, 54, 9406.
[29] Y. Zhao, X. Yang, L. Y. Kuo, P. Kaghazchi, Q. Sun, J. Liang, B. Wang, A. Lushington, R. Li, H. Zhang, X. Sun, Small 2018, 14, 1703717.
[30] Q. Wang, C. Zhao, X. Lv, Y. Lu, K. Lin, S. Zhang, F. Kang, Y. S. Hu, B. Li, J. Mater. Chem. A 2019, 7, 24857.
[31] W. Go, M. H. Kim, J. Park, C. H. Lim, S. H. Joo, Y. Kim, H. W. Lee, Nano Lett. 2019, 19, 1504.
[32] Y. Xu, E. Matios, J. Luo, T. Li, X. Lu, S. Jiang, Q. Yue, W. Li, Y. Kang, Nano Lett. 2021, 21, 816.
[33] X. Wang, L. Fu, R. Zhan, L. Wang, G. Li, M. Wan, X. L. Wu, Z. W. Seh, L. Wang, Y. Sun, ACS Appl. Mater. Interfaces 2021, 13, 13354.
[34] J. Liang, W. Wu, L. Xu, X. Wu, Carbon 2021, 176, 219.
[35] J. Wu, P. Zou, M. Ihsan-UI-Haq, N. Mubarak, A. Susca, B. Li, F. Ciucci, J. K. Kim, Small 2020, 16, 2003815.
[36] L. Zhang, X. Zhu, G. Wang, G. Xu, M. Wu, H. K. Liu, S. X. Dou, C. Wu, Small 2021, 17, 2007578.
[37] X. Zheng, P. Li, Z. Cao, W. Luo, F. Sun, Z. Wang, B. Ding, G. Wang, Y. Huang, Small 2019, 15, 1902688.
[38] M. Zhu, G. Wang, X. Liu, B. Guo, G. Xu, Z. Huang, M. Wu, H. K. Liu, S. X. Dou, C. Wu, Angew. Chem. Int. Ed. 2020, 59, 6596.
[39] C. Bao, B. Wang, Y. Xie, R. Song, Y. Jiang, Y. Ning, F. Wang, T. Ruan, D. Wang, Y. Zhou, ACS Sustain. Chem. Eng. 2020, 8, 5452.
[40] Y. Fang, R. Lian, H. Li, Y. Zhang, Z. Gong, K. Zhu, K. Ye, J. Yan, G. Wang, Y. Gao, Y. Wei, D. Cao, ACS Nano 2020, 14, 8744.
[41] Q. Lu, X. Wang, A. Omar, D. Mikhailova, Mater. Lett. 2020, 275.
[42] Y. Ma, Y. Gu, Y. Yao, H. Jin, X. Zhao, X. Yuan, Y. Lian, P. Qi, R. Shah, Y. Peng, Z. Deng, J. Mater. Chem. A 2019, 7, 20926.
[43] N. Mubarak, M. Ihsan-Ul-Haq, H. Huang, J. Cui, S. Yao, A. Susca, J. Wu, M. Wang, X. Zhang, B. Huang, J.-K. Kim, J. Mater. Chem. A 2020, 8, 10269.
[44] J. Sun, C. Guo, Y. Cai, J. Li, X. Sun, W. Shi, S. Ai, C. Chen, F. Jiang, Electrochim. Acta 2019, 309, 18.
[45] J. Yan, G. Zhi, D. Kong, H. Wang, T. Xu, J. Zang, W. Shen, J. Xu, Y. Shi, S. Dai, X. Li, Y. Wang, J. Mater. Chem. A 2020, 8, 19843.
[46] K. Yan, S. Zhao, J. Zhang, J. Safaei, X. Yu, T. Wang, S. Wang, B. Sun, G. Wang, NanoLett. 2020, 20, 6112.
[47] X. Hu, E. Matios, Y. Zhang, C. Wang, J. Luo, W. Li, Angew. Chem. Int. Ed. 2021, 60, 5978.
[48] X. Liu, X. Zheng, Y. Dai, W. Wu, Y. Huang, H. Fu, Y. Huang, W. Luo, Adv. Funct. Mater. 2021, 2103522.
[49] C. Lu, Z. Gao, B. Liu, Z. Shi, Y. Yi, W. Zhao, W. Guo, Z. Liu, J. Sun, Adv. Funct. Mater. 2021, 31, 2101233.
[50] a) B. Sun, P. Xiong, U. Maitra, D. Langsdorf, K. Yan, C. Wang, J. Janek, D. Schröder, G. Wang, Adv. Mater 2020, 32, 1903891; b) Y. Zhao, K. R. Adair, X. Sun, Energy Environ. Sci. 2018, 77, 2673; c) S. Guo, J. Yi, Y. Sun, H. Zhou, Energy Environ. Sci. 2016, 9, 2978; d) W. Luo, L. Hu, ACS Cent. Sci. 2015, 7, 420.
[51] a) Y. Liang, H. Dong, D. Aurbach, Y. Yao, Nat. Energy 2020, 5, 646; b) C. Yang, K. Fu, Y. Zhang, E. Hitz, L. Hu, Adv. Mater. 2017, 29, 1701169; c) G. J. Rees, D. S. Jolly, Z. Ning, T. J. Marrow, G. E. Pavlovskaya, P. G. Bruce, Angew. Chem., Int. Ed. 2021, 60, 2110.
[52]a) D. Lin, Y. Liu, Y. Cui, Nat. Nanotechnol. 2017, 72, 194; b) P. Zou, Y. Sui, H. Zhan, C. Wang, H. L. Xin, H. M. Cheng, F. Kang, C. Yang, Chem. Rev. 2021, 727, 5986; c) B. Lee, E. Paek, D. Mitlin, S. W. Lee, Chem. Rev. 2019, 779, 5416; d) H. Wang, E. Matios, J. Luo, W. Li, Chem. Soc. Rev. 2020, 49, 3783; e) W. Zhou, Y. Li, S. Xin, J. B. Goodenough, ACS Cent. Sci. 2017, 3, 52; f) L. Lin, L. Suo, Y. Hu, H. Li, X. Huang, L. Chen, Adv, Energy Mater. 2021, 77, 2003709.
[53] a) S. Wei, S. Choudhury, J. Xu, P. Nath, Z. Tu, L. A. Archer, Adv. Mater. 2017, 29, 1605512; b) J. Zheng, M. H. Engelhard, D. Mei, S. Jiao, B. J. Polzin, J. G. Zhang, ‘W’. Xu, Nat. Energy 2017, 2, 17012.
[54] W. Luo, C. F. Lin, O. Zhao, M. Noked, Y. Zhang, G. W. Rubioff, L. Hu, Adv. Energy Mater 2017, 7, 1601526.
[55] a) S. Chen, J. Zheng, D. Mei, K. S. Han, M. H. Engelhard, W. Zhao, W. Xu, J. Liu, J. G. Zhang, Adv. Mater. 2018, 30, 1706102; b) M. D. Tikekar, S. Choudhury, Z. Tu, L. A. Archer, Nat. Energy 2016, 7, 16114; c) D. Zhang, S. Wang, B. Li, Y. Gong, S. Yang, Adv. Mater. 2019, 37, 1901820, d) K. Yan, Z. Lu, H. W. Lee, F. Xiong, P. C. Hsu, Y. Li, J. Zhao, S. Chu, Y. Cui, Nat. Energy 2016, 7, 16010; e) J. Wu, Z. Rao, X. Liu, Y. Shen, C. Fang, L. Yuan, Z. Li, W. Zhang, X. Xie, Y. Huang, Adv. Mater. 2021, 33, 2007428; f) C. Yan, X. B. Cheng, Y. X. Yao, X. Shen, B. Q. Li, W. J. Li, R. Zhang, J. Q. Huang, H. Li, Q. Zhang, Adv. Mater. 2018, 30, 1804461.
[56] a) G. G. Eshetu, G. A. Elia, M. Armand, M. Forsyth, S. Komaba, T. Rojo, S. Passerini, Adv. Energy Mater. 2020, 70, 2000093; b) C. Bao, B. Wang, P. Liu, H. Wu, Y. Zhou, D. Wang, H. Liu, S. Dou, Adv. Funct. Mater. 2020, 30, 2004891.
[57] a) Y. Xu, Y. Zhu, Y. Liu, C. Wang, Adv. Energy Mater. 2013, 3, 128; b) N. Yabuuchi, K. Kubota, M. Dahbi, S. Komaba, Chem. Rev. 2014, 774, 11636.
[58] a) Y. Okamoto, J. Phys. Chem. C 2013, 778, 16; b) C. Luo, Y. Zhu, Y. Wen, J. Wang, C. Wang, Adv. Funct. Mater. 2014, 24, 4082.
[59] a) S. Choudhury, S. Wei, Y. Ozhabes, D. Gunceler, M. J. Zachman, Z. Tu, J. H. Shin, P. Nath, A. Agrawal, L. F. Kourkoutis, T. A. Arias, L. A. Archer, Nat. Commun. 2017, 8, 898; b) H. J. Yoon, N. R. Kim, H. J. Jin, Y. S. Yun, Adv. Energy Mater. 2018, 8, 1701261; c) Z. W. Seh, J. Sun, Y. Sun, Y. Cui, ACS Cent. Sci. 2015, 7, 449; d) W. Liu, P. Li, W. Wang, D. Zhu, Y. Chen, S. Pen, E. Paek, D. Mitlin, ACS Nano 2018, 72, 12255.
[60] a) A. Wang, X. Hu, H. Tang, C. Zhang, S. Liu, Y. W. Yang, Q. H. Yang, J. Luo, Angew. Chem, Int. Ed. 2017, 56, 11921; b) H. Wang, C. Wang, E. Matios, W. Li, Nano Lett. 2017, 77, 6808; c) R. Rodriguez, K. E. Loeffler, S. S. Nathan, J. K. Sheavly, A. Dolocan, A. Heller, C. B. Mullins, ACS Energy Lett. 2017, 2, 2051; d) P. Shi, S. Zhang, G. Lu, L. Wang, Y. Jiang, F. Liu, Y. Yao, H. Yang, M. Ma, S. Ye, X. Tao, Y. Feng, X. Wu, X. Rui, Y. Yu, Adv. Energy Mater. 2020, 77, 2003381; e) Y. Deng, J. Zheng, A. Warren, J. Yin, S. Choudhury, P. Biswal, D. Zhang, L. A. Archer, Adv. Energy Mater. 2019, 9, 1901651.
[61] P. Bai, J. Li, F. R. Brushett, M. Z. Bazant, Energy Environ. Sci 2016, 9, 3221.
[62] a) X. Zheng, H. Fu, C. Hu, H. Xu, Y. Huang, J. Wen, H. Sun, W. Luo, Y. Huang, J. Phys. Chem. Lett. 2019, 70, 707; b) S. Wang, W. Cai, Z. Sun, F. Huang, Y. Jie, Y. Liu, Y. Chen, B. Peng, R. Cao, G. Zhang, S. Jiao, Chem. Commun. 2019, 55, 14375; c) X Zheng, Z. Gu, X Liu, Z. Wang, J. Wen, X. Wu, W. Luo, Y. Huang, Energy Environ. Sci. 2020, 73, 1788; d) X. Hu, E. Matios, Y. Zhang, C. Wang, J. Luo, W. Li, Angew. Chem., Int. Ed. 2021, 60, 5978.
[63] a) Z. Tu, S. Choudhury, M. J. Zachman, S. Wei, K. Zhang, L. F. Kourkoutis, L. A. Archer, Nat. Energy 2018, 3, 310; b) Y. Zhao, L. V. Goneharova, A. Lushington, Q. Sun, H. Yadegari, B. Wang, W. Xiao, R. Li, X. Sun, Adv. Mater. 2017, 29, 1606663; c) Z. Xu, J. Yang, T. Zhang, L. Sun, Y. Nuli, J. Wang, S. Hirano, Adv. Funct. Mater. 2019, 29, 1901924; d) C. Xiao, R. Usiskin, J. Maier, Adv. Funct. Mater. 2021, 37, 2100938; e) L. Zhang, X. Zhu, G. Wang, G. Xu, M. Wu, H. K. Liu, S. X DoLu, C. Wu, Small 2021, 77, 2007578, f) M. Zhu, G. Wang, X. Liu, B. Guo, G. Xu, Z. Huang, M. Wu, H. K. Liu, S. X. Dou, C. Wu, Angew. Chem., Int. Ed. 2020, 59, 6596.
[64] a) Y. Zhang, C. Wang, G. Pastel, Y. Kuang, H. Xie, Y. Li, B. Liu, W. Luo, C. Chen, L. Hu, Adv. Energy Mater. 2018, 8, 1800635; b) F. Wu, J. Zhou, R. Luo, Y. Huang, Y. Mei, M. Xie, R. Chen, Energy Storage Mater. 2019, 22, 376; c) Q. Wang, C. Zhao, X. Lv, Y. Lu, K. Lin, S. Zhang, F. Kang, Y. S. Hu, B. Li, J. Mater. Chem. A 2019, 7, 24857; d) Y. Zhao, X. Yang, L. Y. Kuo, P. Kaghazchi, Q. Sun, J. Liang, B. Wang, A. Lushington, R. Li, H. Zhang, X. Sun, Small 2018, 74, 1703717; e) S.-S. Chi, X.-G. Qi, Y.-S. Hu, L.-Z. Fan, Adv. Energy Mater. 2018, 8, 1702764; f) T. Li, J. Sun, S. Gao, B. Xiao, J. Cheng, Y. Zhou, X. Sun, F. Jiang, Z. Yan, S. Xiong, Adv. Energy Mater. 2020, 77, 2003699; g) X. Zheng, P. Li, Z. Cao, W. Luo, F. Sun, Z. Wang, B. Ding, G. Wang, Y. Huang, Small 2019, 75, 1902688; h) X. He, S. Jin, L. Miao, Y. Cai, Y. Hou, H. Li, K. Zhang, Z. Yan, J. Chen, Angew. Chem., Int. Ed. 2020, 59, 16705.
[66] a) A. P. Cohn, N. Muralidharan, R. Carter, K. Share, C. L. Pint, Nano Lett. 2017, 77, 1296; b) S. Tang, Z. Qiu, X Y. Wang, Y. Gu, X. G. Zhang, W. W. Wang, J. W. Yan, M. S. Zheng, Q. F. Dong, B. W. Mao, Nano Energy 2018, 48, 101; c) B. Sun, P. Li, J. Zhang, D. Wang, P. Munroe, C. Wang, P. H. L. Notten, G. Wang, Adv. Mater. 2018, 30, 1801334; d) S. Tang, Y. Y. Zhang, X G. Zhang, J. T. Li, X. Y. Wang, J. W. Yan, D. Y. Wu, M. S. Zheng, Q. F. Dong, B. W. Mao, Adv. Mater 2019, 37, 1807495; e) Y. Xu, C, Wang, E. Matios, J. Luo, X. Hu, Q. Yue, Y. Kang, W. Li, Adv. Energy Mater 2020, 70, 2002308; f) J. Wu, P. Zou, M. Ihsan-Ul-Haq, N. Mubarak, A. Susca, B. Li, F. Ciucci, J. K. Kim, Small 2020, 76, 2003815.
[67] X. Zheng, W. Yang, Z. Wang, L. Huang, S. Geng, J. Wen, W. Luo, Y. Huang, Nano Energy 2020, 69, 104387.
[68] W. Liu, Z. Chen, Z. Zhang, P. Jiang, Y. Chen, E. Paek, Y. Wang, D. Mitlin, Energy Environ. Sci. 2021, 74, 382.
[69] a) M. E. Lee, S. Lee, J. Choi, H. J. Jin, S. Han, Y. S. Yun, Small 2019, 75, 1901274; b) J. Qian, B. D. Adams, J. Zheng, W. Xu, W. A. Henderson, J. Wang, M. E. Bowden, S. Xu, J. Hu, J. G. Zhang, Adv. Funct. Mater. 2016, 26, 7094; c) J. G. Zhang, Nat. Energy 2019, 4, 637.
[70] Y. Lee, J. Lee, J. Lee, K. Kim, A. Cha, S. Kang, T. Wi, S. J. Kang, H. W. Lee, N. S. Choi, ACS Appl. Mater. Interfaces 2018, 70, 15270.
[71] a) X. Xu, D. Zhou, X. Qin, K. Lin, F. Kang, B. Li, D. Shanmukaraj, T. Rojo, M. Armand, G. Wang, Nat. Commun. 2018, 9, 3870; b) Y. Wang, D. Zhou, V. Palomares, D. Shanmukaraj, B. Sun, X. Tang, C. Wang, M. Armand, T. Rojo, G. Wang, Energy Environ. Sci. 2020, 73, 3848, c) Y. X. Wang, B. Zhang, W. Lai, Y. Xu, S. L. Chou, H. K. Liu, S. X. Dou, Adv. Energy Mater 2017, 7, 1602829.
[72] a) L. Schafzahi, I. Hanzu, M. Wilkening, S. A. Freunberger, Chem-SusChem 2017, 70, 401; b) P. M. L. Le, T. D. Vo, H. Pan, Y. Jin, Y. He, X. Cao, H. V. Nguyen, M. H. Engelhard, C. Wang, J. Xiao, J. G. Zhang, Adv. Funct. Mater 2020, 30, 2001151.
[73] a) Y. Fang, R. Lian, H. Li, Y. Zhang, Z. Gong, K. Zhu, K. Ye, J. Yan, G. Wang, Y. Gao, Y. Wei, D. Cao, ACS Nano 2020, 74, 8744; b) X. Zhang, F. Hao, Y. Cao, Y. Xie, S. Yuan, X. Dong, Y. Xia, Adv. Funct. Mater. 2021, 37, 2009778.
[74] a) CASM v0.2.1, https://github.com/prisms-center/CASMcode (accessed: August 2020); b) CASM v0.2.1, https://doi.org/10.5281/zenodo.546148 (accessed: August 2020).
[75] Z. Yang, J. Sun, Y. Ni, Z. Zhao, J. Bao, S. Chen, Energy Storage Mater 2017, 9, 214.
[76] a) N. Zhao, C. Li, X. Guo, Phys. Chem. Chem, Phys. 2014, 76, 15646; b) G. V. Zhuang, B. S. Mun, P. N. Ross Jr., J. Chem. Phys. 2009, 737, 084502.
[77] J. Zhang, Y. X. Yin, Y. G. Guo, ACS Appl. Mater. Interfaces 2015, 7, 27838.
[78] a) S. Komaba, T. Ishikawa, N. Yabuuchi, W. Murata, A. Ito, Y. Ohsawa, ACS Appl. Mater. Interfaces 2011, 3, 4165; b) R. Dugas, A. Ponrouch, G. Gachot, R. David, M. R. Palacin, J. M. Tarascon, J. Electrochem. Soc. 2016, 763, A2333.
[79] A. Y. S. Eng, V. Kumar, Y. Zhang, J. Luo, W. Wang, Y. Sun, W. Li, Z. W. Seh, Adv. Energy Mater. 2021, 77, 2003493.
[80] A. P. Cohn, T. Metke, J. Donohue, N. Muralidharan, K. Share, C. L. Pint, J. Mater. Chem, A 2018, 6, 23875.
[81] R. Tran, Z. Xu, B. Radhakrishnan, D. Winston, W. Sun, K. A. Persson, S. P. Ong, Sci. Data 2016, 3, 160080.
[82] W. Liu, P. Liu, D. Mitlin, Chem. Soc. Rev. 2020, 49, 7284.

1. An ionophilic template comprising a microscopic array having a formula of Mₐ(SbₓTe_{y}Vac_{z}), wherein
M comprises one or more of Na, Li, K, Mg, Ca, Al, Zn, or alloys thereof;
a Vac refers to vacancies present in a lattice of the microscopic array;
wherein
0≤a≤100,
0≤x≤1; 0≤y≤1; and 0≤z≤1, wherein
the microscopic array is dispersed within a metal comprising the M, and
wherein the ionophilic template is a support material for a metal anode.

2. (canceled)

3. The ionophilic template of claim 1, wherein the ionophilic template is configured to provide a depth-of-discharge of the metal anode from about 1% to 100%.

4. The ionophilic template of claim 3, wherein the ionophilic template is configured to provide a coulombic efficiency of the metal anode greater than about 50% at a current density from about 0.1 mA cm⁻² to about 10 mA cm⁻².

5. The ionophilic template of claim 3, wherein the ionophilic template is configured to exhibit substantially stable cycling profiles for greater than about 1 hour to up to about ten years.

6. (canceled)

7. (canceled)

8. An electrochemical cell comprising:
a) a support material for a metal anode comprising an ionophilic template comprising a microscopic array having a formula of
Mₐ(SbₓTe_{y}Vac_{z}), wherein
an M comprises one or more of Na, Li, K, Mg, Ca, Al, Zn, or alloys thereof;
a Vac refers to vacancies present in a lattice of the microscopic array;
wherein
0≤a≤100,
0≤x≤1; 0≤y≤1; and 0≤z≤1, wherein
the microscopic array is dispersed within a metal comprising the M, and
b) an electrolyte.

9. (canceled)

10. The electrochemical cell of claim 1, wherein the electrolyte comprises a salt and a non-aqueous solvent.

11. The electrochemical cell of claim 10, wherein the salt comprises a potassium, sodium, lithium, magnesium, calcium, or aluminum salt of bis(fluorosulfonyl) imide, perchlorate, tetrafluoroborate hexafluorophosphate, hexafluroarsenate, or a potassium, sodium, or lithium salt of aluminum tetrachloride, boron tetrachloride iodide, chlorate, borate, iodate, or a combination thereof.

12. The electrochemical cell of claim 10, wherein the non-aqueous solvent comprises dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

13. (canceled)

14. The electrochemical cell of claim 8, wherein the electrolyte is a solid electrolyte comprising sulfide compounds, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

15. The electrochemical cell of claim 8, wherein the electrolyte is a hybrid liquid-solid electrolyte.

16. The electrochemical cell of claim 8, wherein the support material is disposed on a substrate, wherein the substrate comprises stainless steel, aluminum, tungsten, titanium, copper, polymer, or a combination thereof.

17. (canceled)

18. (canceled)

19. (canceled)

20. The electrochemical cell of claim 8, wherein the electrochemical cell further comprises a cathode material, and wherein the cathode is a metal cathode or a composite cathode.

21. (canceled)

22. The electrochemical cell of claim 20, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium-cobalt oxide) cathode, LFP (lithium iron phosphate) cathode, fluoride-based cathode, sulfur selenium cathode, sulfur selenium tellurium cathode, spinels, olivines, or any combination thereof.

23. The electrochemical cell of claim 8, wherein the cell exhibits a substantially stable plating and stripping cycling for at least about 1 hour to up to about ten years at a current density from about 0.1 mA cm⁻² to about 10 mA cm⁻².

24. (canceled)

25. (canceled)

26. (canceled)

27. The electrochemical cell of claim 8, wherein the cell exhibits a specific energy from about 1 to about 1,000 Wh/kg after about 100,000 cycles at a specific power of 1 to about 10,000 W/kg.

28. (canceled)

29. (canceled)

30. A method of making an ionophilic template:
disposing an amount of Sb₂Te₃ within a metal M to form a microscopic array having a formula of Mₐ(SbₓTe_{y}Vac_{z}), wherein
the M comprises one or more of Na, Li, K, Mg, Ca, Al, Zn, or alloys thereof;
a Vac refers to vacancies present in a lattice of the microscopic array;
wherein
0≤a≤100,
0≤x≤1; 0≤y≤1; and 0≤z≤1.

31. (canceled)

32. The method of claim 30, wherein the step of disposing comprises:
i) incorporating Sb₂Te₃ within the metal M by a rolling-folding process or
ii) depositing a thin film of Sb₂Te₃ on the metal M and thermally incorporating Sb₂Te₃ within the metal M; or
iii) chemical and electrochemical dealloying, spin coating, spray drying, thermal and/or hydrothermal, or any combination thereof.

33. (canceled)

34. (canceled)

35. (canceled)

36. (canceled)

37. (canceled)

38. (canceled)

39. (canceled)

40. A method of forming an electrochemical cell:
providing the ionophilic template of claim 1; and
providing an electrolyte, and wherein the electrochemical cell is a battery.

41. (canceled)

42. (canceled)

43. The method of claim 40, wherein the ionophilic template is a support material.

44. The method of claim 43, wherein the support material is disposed on a substrate.
